(19) United States
(12) Patent Application Publication
(10) Pub. No.: US 2024/0408883 A1
(43) Pub. Date: Dec. 12, 2024

(54) INK JET RECORDING METHOD, INK JET RECORDING DEVICE AND AQUEOUS INK

(71) Applicant: CANON KABUSHIKI KAISHA, Tokyo (JP)

(72) Inventors: MIKIO SANADA, Kanagawa (JP); HIDEKI YAMAKAMI, Kanagawa (JP); SHOICHI TAKEDA, Kanagawa (JP); YOSHIYUKI KANEKO, Kanagawa (JP); KOICHI ISHIDA, Tokyo (JP); KYOSUKE TODA, Kanagawa (JP)

(21) Appl. No.: 18/740,278

(22) Filed: Jun. 11, 2024

(30) Foreign Application Priority Data
Jun. 12, 2023 (JP) 2023-096028
May 29, 2024 (JP) 2024-087056

(51) Int. Cl. B41J 2/175; B41J 2/185; C09D 11/322

(52) U.S. Cl. CPC B41J 2/17596; B41J 2/17556; B41J 2/185; C09D 11/322

(57) ABSTRACT

Provided is an ink jet recording method of ejecting an aqueous ink from ejection orifices to record an image on a unit area of a recording medium. Reciprocal scanning of a recording head is performed plural times on the unit area while performing reciprocal scanning in a direction intersecting a conveyance direction of the recording medium. The recording head includes the ejection orifices, a pressure chamber that communicates with the ejection orifices, and an ejection unit that includes an ejection element disposed in the pressure chamber to eject the aqueous ink. The recording head also includes a circulation unit having a supply channel for supplying the aqueous ink to the pressure chamber of the ejection unit, and a collecting channel for collecting the aqueous ink from the pressure chamber. The aqueous ink contains a particle having a specific gravity of 3.8 gram per cubic centimeter (g/cm³) or more.

### BACKGROUND

### Field

The present disclosure relates to an ink jet recording method, an ink jet recording device and an aqueous ink.

### Description of the Related Art

In recent years, an ink jet recording device has been widely used in order to output an advertisement and an exhibit by using a recording medium such as paper or a resin film. In such an application, it is necessary for an image to be eye-catching, an image exhibiting high color developability needs to be recorded. In order to record a photograph-like high-definition image, a multipass type recording method of applying an ink to a unit area by performing a plurality of times of reciprocal scanning while repeatedly performing reciprocal scanning of a recording head and conveyance of a recording medium is advantageous.

Japanese Patent Laid-Open No. 2007-118611 suggests a recording head including a mechanism that makes an ink flow in the vicinity of an ejection orifice of the recording head in order to improve the ejection stability which is a prerequisite for obtaining a high-definition image. The recording head described in Japanese Patent Laid-Open No. 2007-118611 is a line type recording head (line head) in which ejection orifices are arranged over the entire width of the recording medium. When a state where an ink is not ejected from such a recording head for a certain period of time is continued, the use of an ink containing a specific compound has been suggested in Japanese Patent Laid-Open Nos. 2017-226209 and 2017-101232 in order to suppress the ejection stability from being unstable.

The present inventors have examined various characteristics obtained when the ink circulation in the line head described in Japanese Patent Laid-Open No. 2007-118611, which discloses a technique of using a line head, and the ink described in Japanese Patent Laid-Open Nos. 2017-226209 and 2017-101232 are applied to a serial type recording head. As a result, it has been found that the ejection stability can be obtained to some extend by using these techniques, but image unevenness occurs due to the use of a serial type recording head. It has been found that the image unevenness is caused by ejection characteristics and cannot be eliminated even when the ink circulation described in Japanese Patent Laid-Open No. 2007-118611 is used.

### SUMMARY

The present disclosure provides an ink jet recording method that enables suppression of image unevenness even in a case where an image is recorded by a multipass type recording method. Further, the present disclosure further provides an ink jet recording device and an aqueous ink which are used for this ink jet recording method.

According to an aspect of the present disclosure, there is provided an ink jet recording method of ejecting an aqueous ink from a plurality of ejection orifices to record an image on a unit area of a recording medium, the ink jet recording method including performing a plurality of times of reciprocal scanning of a recording head on the unit area while performing reciprocal scanning in a direction intersecting a conveyance direction of the recording medium, wherein the recording head includes the plurality of ejection orifices for ejecting the aqueous ink, a pressure chamber that communicates with the plurality of ejection orifices, an ejection unit that includes an ejection element disposed in the pressure chamber and generating energy for ejecting the aqueous ink from the plurality of ejection orifices, a circulation unit that includes a supply channel for supplying the aqueous ink to the pressure chamber of the ejection unit, a collecting channel for collecting the aqueous ink from the pressure chamber of the ejection unit, and wherein the aqueous ink contains a particle having a specific gravity of 3.8 gram per cubic centimeter (g/cm³) or more.

Further features of the present disclosure will become apparent from the following description of exemplary embodiments with reference to the attached drawings.

### BRIEF DESCRIPTION OF THE DRAWINGS

FIGS. 1A and 1B describe an ink jet recording device.

FIG. 2 is an exploded perspective view showing a recording head.

FIGS. 3A and 3B are respectively a longitudinal cross-sectional view showing the recording head and an enlarged cross-sectional view showing an ejection module.

FIG. 4 is a schematic view showing the outer appearance of a circulation unit.

FIG. 5 is a longitudinal cross-sectional view showing a circulation path.

FIG. 6 is a block view schematically showing the circulation path.

FIGS. 7A, 7B and 7C are cross-sectional views showing an example of a pressure adjustment unit.

FIGS. 8A and 8B are perspective views showing the outer appearance of a circulation pump.

FIG. 9 is a cross-sectional view taken along the line IX-IX of the circulation pump shown in FIG. 8A.

FIGS. 10A to 10E are views showing the flow of an ink in the recording head.

FIGS. 11A and 11B are schematic views showing a circulation path in an ejection unit.

FIG. 12 is a view showing an opening plate 330.

FIG. 13 is a view showing an example of an ejection element substrate.

FIGS. 14A, 14B and 14C are cross-sectional views showing the flow of the ink in the ejection unit.

FIGS. 15A and 15B are cross-sectional views showing an example of the vicinity of an ejection orifice.

FIGS. 16A and 16B are cross-sectional views showing another example of the vicinity of an ejection orifice.

FIG. 17 is a view showing another example of an ejection element substrate.

FIGS. 18A and 18B are views showing a channel configuration of the recording head.

FIG. 19 is a view showing a state of connection between a main body portion and the recording head of the ink jet recording device.

FIGS. 20A to 20G are schematic views showing a difference in image unevenness depending on recording systems.

FIGS. 21A and 21B are schematic views showing movement of a solid component in the vicinity of the ejection orifice.

FIG. 22 is a perspective view showing a linear recording head.

FIG. 23 is a schematic view showing an image recorded in an example.

### DESCRIPTION OF THE EMBODIMENTS

Hereinafter, the present disclosure will be described in more detail with reference to preferred embodiments. In the present disclosure, in a case where a compound is a salt, the salt is present by being dissociated in an ion state in an ink, but the expression “containing a salt” is used for convenience. Titanium oxide and a titanium oxide particle will also be simply referred to as “pigment”. Further, an ink jet aqueous ink will also be simply referred to as “ink”. A physical value is a value at room temperature (25° C.) unless otherwise specified. The term “(meth)acrylic acid” denotes “acrylic acid” or “methacrylic acid”, and the term “(meth)acrylate” denotes “acrylate” or “methacrylate”.

The present inventors have examined the reason why image unevenness occurs when an image is recorded by applying the ink circulation described in Japanese Patent Laid-Open No. 2007-118611 to a serial type recording head and ejecting an ink containing oleic acid as the specific compound described in Japanese Patent Laid-Open No. 2017-226209. Specifically, the present inventors have confirmed a phenomenon occurring in the vicinity of an ejection orifice of a recording head where image unevenness has occurred. It is considered that oleic acid is likely to be precipitated when a liquid component such as water in the ink evaporates and is aligned in a meniscus portion on a liquid surface of the ejection orifice. Therefore, the meniscus portion of the ejection orifice is in a state where the precipitated oleic acid forms a film, and thus further evaporation of the liquid component such as water is considered to be suppressed. As a result, it is considered that since an increase in viscosity of the ink in the viscosity of the ejection orifice is suppressed, degradation of ejection properties can be suppressed.

However, a loss of ejection energy actually occurs when the ink is ejected due to the influence of a slight increase in viscosity of the ink and the presence of a film, and as a result, the volume of ink droplets to be ejected is decreased. In a recording method using a line head, an aqueous ink is ejected to a unit area by performing relative scanning carried out once between the recording head and the recording medium. Therefore, in a case where a line head is used, since the ejection volume per one droplet relatively increases as compared with a serial type recording head, the influence of a slight decrease in volume of liquid droplets to be ejected can be ignored. Therefore, a slight decrease in volume of ink droplets is not at a level where the decrease can be visually recognized with an image, and thus image unevenness does not occur. Meanwhile, the influence of the decrease in volume of ink droplets is wide when a serial type recording head is used, and is at a level where the decease can be visually recognized in the form of image unevenness. Hereinafter, a phenomenon occurring when a serial type recording head is used will be described.

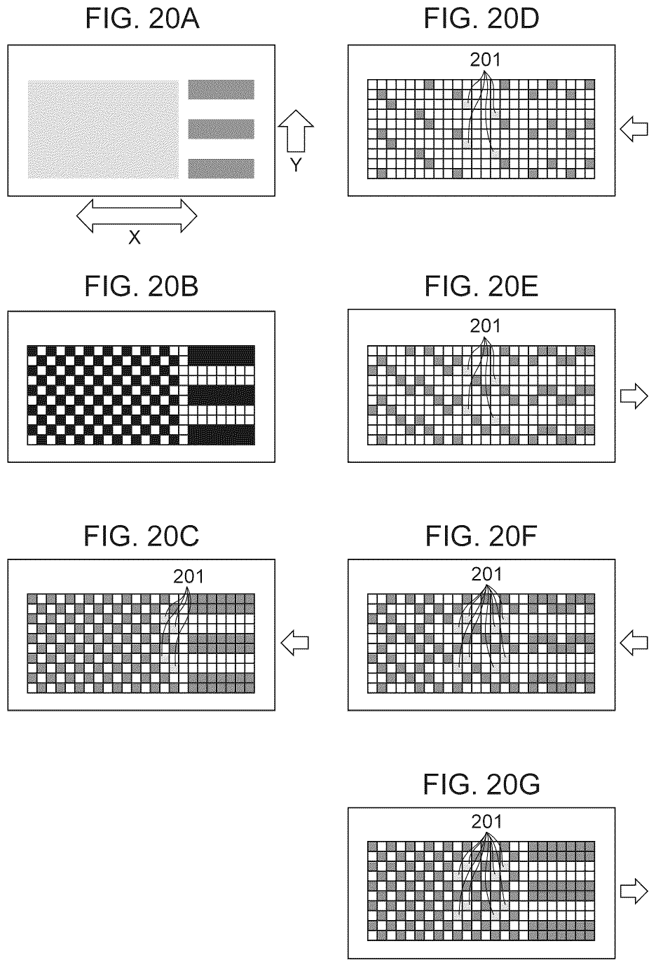

As shown in FIG. 20A, a case of recording a pattern in which a region (1) where the amount of ink applied is relatively larger (right side of FIG. 20A) and a region (2) where the amount of ink applied is relatively smaller (left side of FIG. 20A) are adjacent to each other will be described as an example. Here, as shown in FIG. 20A, it is assumed that the recording head performs scanning in the X direction, and the recording medium is conveyed in the Y direction. FIG. 20B is a schematic view showing positions where ink droplets for recording the pattern of FIG. 20A are applied. Hereinafter, in a case where the ink is applied to a unit area by relative scanning performed n times between the recording head and the recording medium, this type of recording will be referred to as n-pass recording. A case where recording is performed with a line type recording head corresponds to one pass recording, and the number of passes can be set to an optional number in a case where recording is performed with a serial type recording. The recording speed is decreased when the number of recording passes is increased, but bleeding of ink is unlikely to occur, and thus the number of recording passes is increased in order to record a high-definition image.

As shown in FIG. 20A, a case of recording a pattern in which a region (1) where the amount of ink applied is relatively larger (right side of FIG. 20A) and a region (2) where the amount of ink applied is relatively smaller (left side of FIG. 20A) are adjacent to each other will be described as an example. Here, the recording head performs scanning in the X direction, and the recording medium is conveyed in the Y direction (FIG. 20A). FIG. 20B is a schematic view showing positions where ink droplets for recording the pattern of FIG. 20A are applied. Hereinafter, in a case where the ink is applied to a unit area by relative scanning performed n times between the recording head and the recording medium, this type of recording will be referred to as n-pass recording. A case where recording is performed with a line type recording head corresponds to one pass recording, and the number of passes can be set to an optional number in a case where recording is performed with a serial type recording. The recording speed is decreased when the number of recording passes is increased, but bleeding of ink is unlikely to occur, and thus the number of recording passes is increased in order to record a high-definition image.

Next, a case of recording the above-described pattern in four passes will be described. A state where ejection failure occurs in a region to which the ink is applied in each recording pass is shown in FIGS. 20D to 20G. In FIGS. 20D to 20G, the numerical value 201 denotes the sites where ejection failure has occurred. Further, the scanning direction of the recording head in each recording pass is indicated by an arrow. Even in a case of four-pass recording, a region affected by a decrease in ejection volume is present. Further, since the ink is applied to a unit area by a plurality of times of reciprocal scanning of the recording head, the region affected by the decrease expands. For this reason, strip-like image unevenness is considered to occur.

In consideration of the above-described phenomenon, the present inventors have examined the composition of an ink in order to suppress a decrease in volume of ink droplets. As a result, the present inventors have found that a decrease in volume of ink droplets is suppressed so that the issue of image unevenness can be addressed by using an ink containing a specific particle.

That is, an ink jet recording method of the present disclosure has the following characteristics. First, a recording head is a recording head including a plurality of ejection orifices for ejecting an aqueous ink, a pressure chamber that communicates with the plurality of ejection orifices, an ejection unit that includes an ejection element disposed in the pressure chamber and generating energy for ejecting the aqueous ink from the plurality of ejection orifices, and a circulation unit that includes a supply channel for supplying the aqueous ink to the pressure chamber of the ejection unit and a collecting channel for collecting the aqueous ink from the pressure chamber of the ejection unit. Further, the aqueous ink contains a particle having a specific gravity of 3.8 gram per cubic centimeter (g/cm³) or more. Further, the aqueous ink is ejected to record an image on a unit area of a recording medium by performing a plurality of times of reciprocal scanning on the unit area while performing reciprocal scanning of the recording head in a direction intersecting a conveyance direction of the recording medium.

The present inventors assume that the mechanism by which the image unevenness can be suppressed with the above-described configuration is as follows. The recording head includes a plurality of ejection orifices for ejecting an aqueous ink, a pressure chamber that communicates with the plurality of ejection orifices, an ejection unit that includes an ejection element disposed in the pressure chamber and generating energy for ejecting the aqueous ink from the plurality of ejection orifices, and a circulation unit that includes a supply channel for supplying the aqueous ink to the pressure chamber of the ejection unit and a collecting channel for collecting the aqueous ink from the pressure chamber of the ejection unit. A decrease in ejection stability caused by local evaporation of the ink can be suppressed by using the above-described recording head.

The aqueous ink contains a particle having a specific gravity of 3.8 gram per cubic centimeter (g/cm³) or more. This particle is a particle having a particularly large specific gravity among components added to an ink jet aqueous ink. Hereinafter, the particle will also be referred to as a high specific gravity particle. When the recording head performs reciprocal scanning, the inertial force acts on the high specific gravity particle in a case of acceleration and deceleration during the reciprocal scanning, and thus the ink is sufficiently stirred. As a result, it is considered that the image unevenness that cannot be suppressed only by the ink circulation can be suppressed.

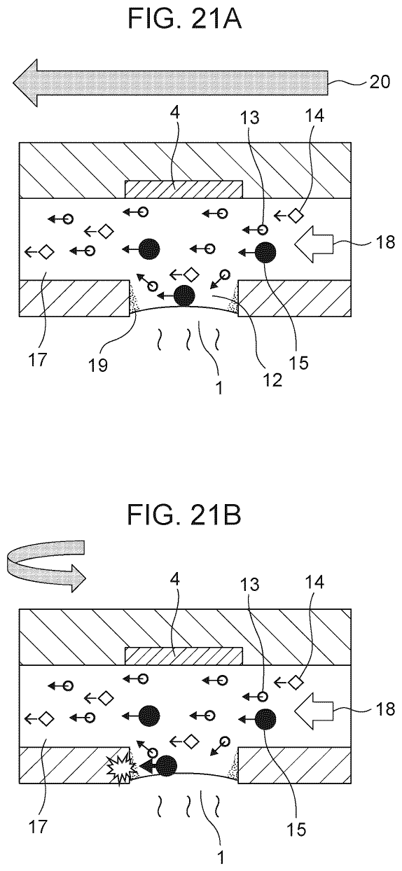

The mechanism of stirring the ink using the high specific gravity particle, which characterizes the present disclosure, will be described in detail with reference to FIGS. 21A and 21B. FIG. 21A is a schematic view showing the high specific gravity particle being stirred in a channel by reciprocal scanning of a carriage where the recording head is disposed. A channel 17 communicates a pressure chamber 12 which is a region between an ejection orifice 1 and an ejection element 4. Here, an example of an ink containing a coloring material 13 and a resin particle 14 in addition to the high specific gravity particle 15 as solid components will be described. Due to the circulation of the ink, the ink containing the solid components flows in a direction indicated by an arrow 18 in the pressure chamber 12 and the channel 17.

When the ink is continuously circulated, the solid components in the ink are likely to stay in an ejection orifice peripheral portion 19 or the like where the ink relatively slowly flows. As a result, the concentration of the solid components increases in the ejection orifice peripheral portion 19, the viscosity locally increases, and thus a decrease in volume of ink droplets occurs. Meanwhile, as shown in FIG. 21B, after the recording head performs scanning in a forward direction, the scanning direction of the carriage is an opposite direction (backward direction) in the returning route, and accordingly, the direction of the acceleration is exactly opposite. Therefore, a force (inertial force) acts on the solid components in the ink inn a direction in which the movement speed of the carriage is reduced. As a result, the solid components in the ink collide with a wall surface of the ejection orifice peripheral portion 19. Among the solid components, the impact of the high specific gravity particle 15 increases due to the collision, and thus the ink in the ejection orifice peripheral portion can be sufficiently stirred. As a result, an increase in viscosity of the ink in the ejection orifice peripheral portion is suppressed, and thus the image unevenness can be suppressed.

In a case where the aqueous ink does not contain such a high specific gravity particle, the effect of sufficiently stirring the ink in the ejection orifice peripheral portion is not exhibited even when the ink circulation or the reciprocal scanning is performed, and thus the image unevenness cannot be suppressed. Further, in a case where the recording head is a line head, the image unevenness is not visually recognized in the first place even when the reciprocal scanning is not performed.

### <Ink Jet Recording Method, Ink Jet Recording Device and Aqueous Ink>

The ink jet recording method of the present disclosure is a method of recording an image by ejecting an aqueous ink using an action of thermal energy from an ink jet type recording head and making the aqueous ink adhere to a recording medium. The recording head includes a plurality of ejection orifices for ejecting an aqueous ink, a pressure chamber that communicates with the plurality of ejection orifices, an ejection unit that includes an ejection element disposed in the pressure chamber and generating energy for ejecting the aqueous ink from the plurality of ejection orifices, and a circulation unit that includes a supply channel for supplying the aqueous ink to the pressure chamber of the ejection unit and a collecting channel for collecting the aqueous ink from the pressure chamber of the ejection unit. Further, the aqueous ink is ejected from the plurality of ejection orifices to record an image on a unit area of a recording medium by performing a plurality of times of reciprocal scanning on the unit area while performing scanning of the recording head in a direction intersecting the conveyance direction of the recording medium. The aqueous ink contains a particle having a specific gravity of 3.8 gram per cubic centimeter (g/cm³) or more. Further, in the present disclosure, it is not necessary to provide a step of irradiating the image with active energy rays or the like to cure the image.

Further, the ink jet recording device of the present disclosure is a device used for an ink jet recording method of recording an image by ejecting an aqueous ink using an action of thermal energy from an ink jet type recording head and making the aqueous ink adhere to a recording medium. The ink jet recording device of the present disclosure is a device suitably used for the recording method.

The aqueous ink of the present disclosure is an aqueous ink used for the ink jet recording method of recording an image by ejecting an aqueous ink from an ink jet type recording head and making the aqueous ink adhere to a recording medium. Further, the aqueous ink is suitably used for the recording method.

Hereinafter, the ink jet recording method and the ink jet recording device (hereinafter, also simply referred to as “recording method” and “recording device”) of the present disclosure will be described in detail. Here, in the following preferred embodiment, an example of employing a thermal method of ejecting the ink by generating air bubbles using an electrothermal converting element as the ejection element that ejects the ink will be described, but the present disclosure is not limited thereto. For example, the same applies to a recording head for which an ejection method of ejecting an ink using a piezoelectric (piezo) element or other ejection methods are employed. Further, a pump, a pressure adjustment unit and the like described below are not limited to the configurations described in the preferred embodiments and the accompanying drawings.

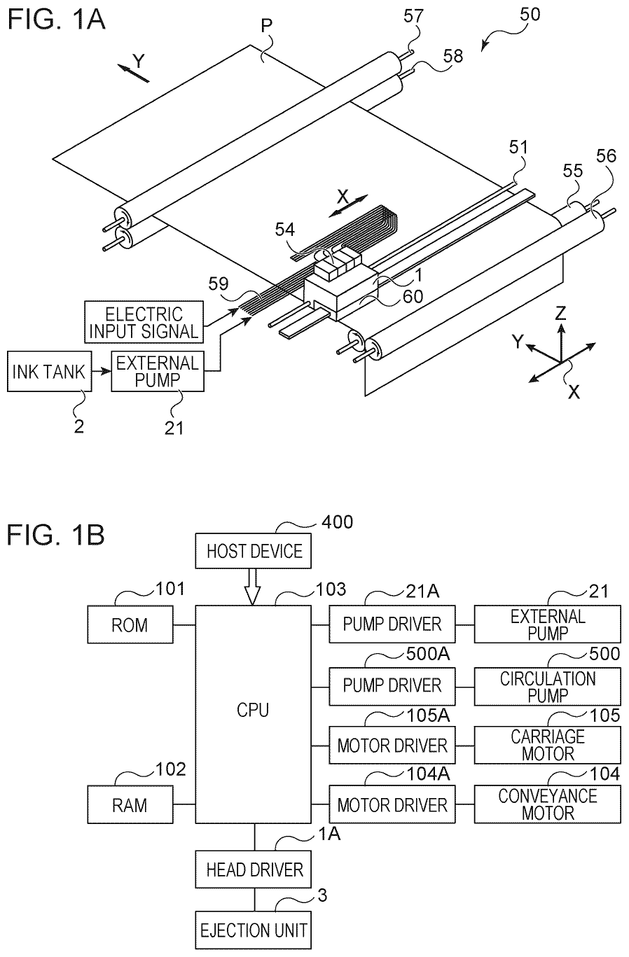

FIG. 1A is a view for describing an ink jet recording device, which is an enlarged view showing a recording head and the periphery of the recording head of the ink jet recording device. First, a schematic configuration of an ink jet recording device 50 according to the present embodiment will be described with reference to FIG. 1A. FIG. 1A is a perspective view schematically showing the ink jet recording device formed of a recording head 1. The ink jet recording device 50 according to the present embodiment is a serial type ink jet recording device that performs recording on a recording medium P by ejecting the ink, which is a liquid, while the recording head 1 performs scanning.

The recording head 1 is mounted on a carriage 60. The carriage 60 reciprocally moves in a main scanning direction (X direction) along a guide shaft 51. The recording medium P is conveyed in a sub-scanning direction (Y direction) intersecting (in a case of the present example, orthogonal to) the main scanning direction by conveyance rollers 55, 56, 57 and 58. Further, in each of the following views to be referred to, a Z direction denotes the vertical direction and intersects (in a case of the present example, orthogonal to) an X-Y plane defined by the X direction and the Y direction. The recording head 1 is configured to be attachable to and detachable from the carriage 60 by a user.

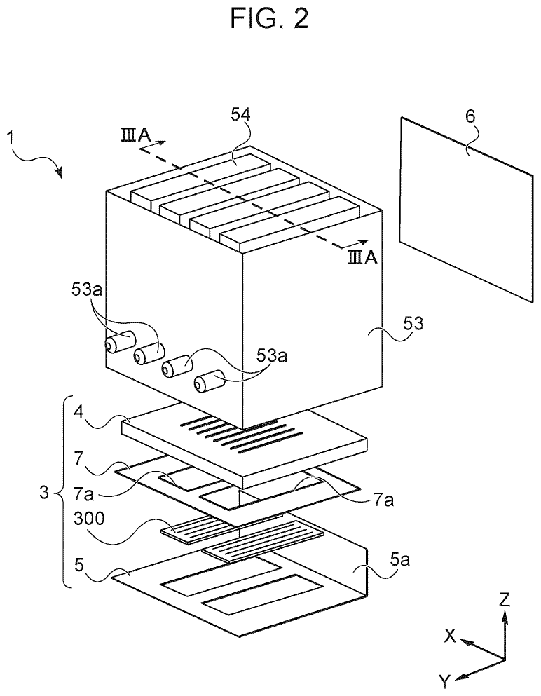

The recording head 1 is configured to include a circulation unit 54 and an ejection unit 3 (see FIG. 2) described below. As will be described in detail, the ejection unit 3 is provided with a plurality of ejection orifices and an energy generating element (hereinafter, referred to as an ejection element) that generates ejection energy for ejecting the ink from each of the ejection orifices.

The recording head 1 may include a mechanism (temperature adjustment mechanism) that heats the aqueous ink ejected from the recording head. In a case where the recording head includes the temperature adjustment mechanism, the heating temperature of the ink ejected from m the recording head is preferably 35° C. or higher to 70° C. or lower.

Further, the ink jet recording device 50 is provided with an ink tank 2 serving as a supply source of the ink and an external pump 21, and the ink stored in the ink tank 2 is supplied to the circulation unit 54 through an ink supply tube 59 by a driving force of the external pump 21.

The ink jet recording device 50 records a predetermined image on the recording medium P by repeatedly performing recording scanning in which recording is carried out by ejecting the ink while the recording head 1 mounted on the carriage 60 moves in the main scanning direction and a conveyance operation of conveying the recording medium P in the sub-scanning direction. That is, the aqueous ink is ejected to record an image on a unit area of the recording medium by performing a plurality of times of reciprocal scanning of the recording head 1 on the unit area in a direction intersecting the conveyance direction of the recording medium. Here, the unit area can be set as an optional area such as one pixel or one band. Further, the recording head 1 according to the present embodiment can eject four kinds of inks, black (K), cyan (C), magenta (M) and yellow (Y), and thus can record a full color image by using these inks. However, the inks that can be ejected from the recording head 1 are not limited to the above-described four kinds of inks. The present disclosure can be applied to a recording head for ejecting other kinds of inks. That is, the kind and the number of ink ejected from the recording head are not limited. Among examples of the ink, a white (W) ink obtained by using, as a coloring material, titanium oxide serving as the high specific gravity particle is preferable. The titanium oxide has a large particle diameter for whiteness in some cases, and has a specific gravity larger than that of a coloring material typically used in an ink. The image unevenness can be suppressed by using the above-described recording head even for such an ink.

The movement speed (scanning speed, inch/s) of the recording head during the reciprocal scanning is preferably 20 inch/s or more. More specifically, the movement speed of the recording head with respect to the recording medium P during the recording is preferably 20 inch/s or more. When the scanning speed thereof is less than 20 inch/s, the inertial force acting on the high specific gravity particle decreases, the ejection interval is widened, and as a result, the image unevenness cannot be sufficiently suppressed in some cases. The scanning speed is preferably 100 inch/s or less and more preferably 80 inch/s or less. When the scanning speed is more than 100 inch/s, foaming of the ink is likely to be significant, and the ejection stability cannot be sufficiently obtained in some cases. As a result, the image unevenness cannot be sufficiently suppressed.

Further, the ink jet recording device 50 is provided with a cap member (not shown) capable of covering the ejection orifice surface in which the ejection orifices of the recording head are formed, at a position separated from a conveyance path of the recording medium P in the X direction. The cap member covers the ejection orifice surface of the recording head 1 during a non-recording operation and is used to prevent the ejection orifices from being dried, protect the ejection orifices and carry out an ink suction operation or the like from the ejection orifices.

In the recording head 1 shown in FIG. 1A, an example in which four circulation units 54 corresponding to four kinds of inks are provided in the recording head 1 is shown, but the recording head 1 is not limited as long as the recording head 1 is provided with the circulation head 54 corresponding to the kind of the ink to be ejected. Further, the recording head 1 may be provided with a plurality of circulation units 54 for the same kind of ink. That is, the recording head 1 can be configured to include one or more circulation units. Further, the recording head 1 may be configured to circulate only at least one ink without circulating all four kinds of inks.

FIG. 1B is a block view showing a control system of the ink jet recording device 50. A CPU 103 functions as a control unit that controls the operation of each part of the ink jet recording device 50 based on the programs of the processing procedures and the like stored in a ROM 101. A RAM 102 is used as a work area or the like when the CPU 103 executes processing. The CPU 103 controls a head driver 1A by receiving image data from a host device 400 provided outside the ink jet recording device 50 and controls driving of the ejection element provided in the ejection unit 3. Further, the CPU 103 controls drives of various actuators provided in the ink jet recording device. For example, the CPU 103 controls a motor driver 105A of a carriage motor 105 for moving the carriage 60 and a motor driver 104A of a conveyance motor 104 for conveying the recording medium P. Further, the CPU 103 controls a pump driver 500A that drives a circulation pump 500 described below, a pump driver 21A of an external pump 21 and the like. Further, FIG. 1B shows a form of the CUP 103 executing the process of receiving image data from the host device 400, but the ink jet recording device 50 may perform the process without relying on the data from the host device 400.

### <Basic Configuration of Recording Head>

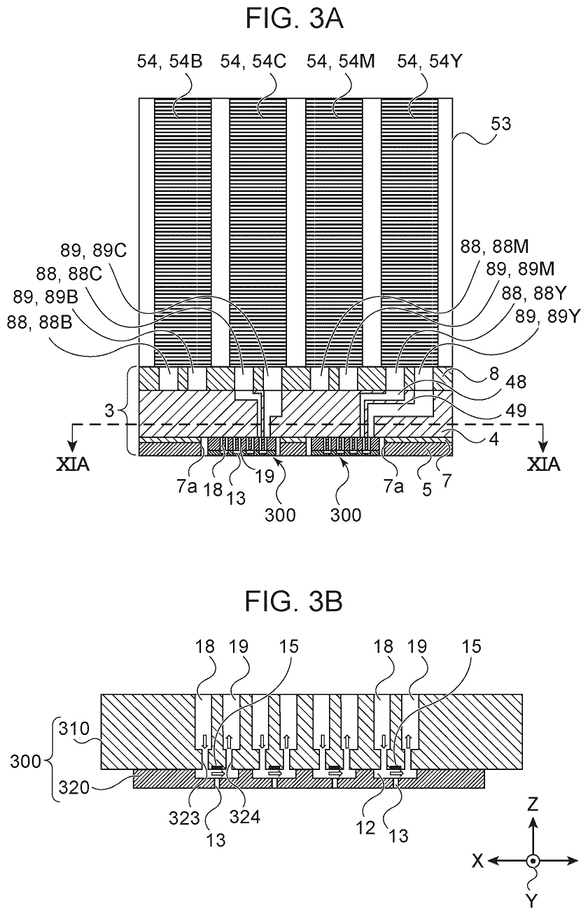

FIG. 2 is an exploded perspective view showing the recording head 1 according to the present embodiment. FIG. 3A is a cross-sectional view taken along the line IIIA-IIIA of the recording head 1 shown in FIG. 2. FIG. 3A is a longitudinal cross-sectional view showing the entire recording head 1, and FIG. 3B is an enlarged view showing an ejection module shown in FIG. 3A. Hereinafter, the basic configuration of the recording head 1 according to the present embodiment will be described with reference to FIGS. 2 to 3B, and FIGS. 1A and 1B as appropriate.

As shown in FIG. 2, the recording head 1 is configured to include the circulation unit 54 and the ejection unit 3 for ejecting the ink supplied from the circulation unit 54 to the recording medium P. The recording head 1 according to the present embodiment is fixedly supported by the carriage 60 of the ink jet recording device 50 due to the electric contact and a positioning unit (not shown) provided on the carriage 60. The recording head 1 performs recording on the recording medium P by jetting the ink while moving in the main scanning direction (X direction) shown in FIG. 1A along with the carriage 60.

The external pump 21 connected to an ink tank 2 serving as a supply source of the ink is provided with an ink supply tube 59 (see FIG. 1A). A liquid connector (not shown) is provided at the tip of the ink supply tube 59. When the recording head 1 is mounted on the ink jet recording device 50, the liquid connector provided at the tip of the ink supply tube 59 is airtightly connected to a liquid connector insertion port 53a, which is an introduction port of the ink, provided in a head housing 53 of the recording head 1. In this manner, an ink supply path is formed from the ink tank 2 to the recording head 1 through the external pump 21. In the present embodiment, since four kinds of inks are used, four sets of ink tanks 2, external pumps 21, ink supply tubes 59 and circulation units 54 are respectively provided corresponding to the inks, and four ink supply paths corresponding to each ink are independently formed. In this manner, the ink jet recording device 50 according to the present embodiment includes an ink supply system that supplies the ink from the ink tank 2 provided outside the recording head 1. Further, the ink jet recording device 50 according to the present embodiment does not include an ink collection system that collects the ink inside the recording head 1 into the ink tank 2. Therefore, the recording head 1 is provided with the liquid connector insertion port 53a for connecting the ink supply tube 59 of the ink tank 2, but is not provided with a connector insertion port that connects a tube for collecting the ink inside the recording head 1 into the ink tank 2. The liquid connector insertion port 53a is provided for each ink.

In FIG. 3A, the reference numeral 54B denotes a circulation unit for a black ink, the reference numeral 54C denotes a circulation unit for a cyan ink, the reference numeral 54M denotes a circulation unit for a magenta ink, and the reference numeral 54Y denotes a circulation unit for a yellow ink. The respectively circulation units have configurations which are substantially the same as each other, and will be collectively referred to as the circulation unit 54 in a case where the circulation units of the present embodiment are not particularly distinguished from each other.

In FIGS. 2 and 3A, the ejection unit 3 includes two ejection modules 300, a first support member 4, a second support member 7, an electrical wiring member (electrical wiring tape) 5 and an electrical contact substrate 6. As shown in FIG. 3B, the ejection module 300 includes a silicon substrate 310 with a thickness of 0.5 to 1 mm and a plurality of ejection elements 15 provided on one surface of the silicon substrate 310. The ejection element 15 according to the present embodiment is formed of an electrothermal conversion element (heater) that generates thermal energy as ejection energy for ejecting the ink.

The power is supplied to each ejection element 15 through an electrical wiring formed on the silicon substrate 310 by a film forming technique.

Further, an ejection orifice forming member 320 is formed on the surface (lower surface in FIG. 3B) of the silicon substrate 310. A plurality of pressure chambers 12 corresponding to a plurality of ejection elements 15 and a plurality of ejection orifices 13 ejecting the ink are respectively formed in the ejection orifice forming member 320 by a photolithography technique. Further, a common supply channel 18 and a common collecting channel 19 are formed in the silicon substrate 310. In addition, a supply connection channel 323 communicating the common supply channel 18 with each pressure chamber 12 and a collection connection channel 324 communicating the common collecting channel 19 with each pressure chamber are formed in the silicon substrate 310. In the present embodiment, one ejection module 300 is configured to eject two kinds of inks. That is, between two ejection modules shown in FIG. 3A, the ejection module 300 positioned on the left side in the figure ejects a black ink and a cyan ink, and the ejection module 300 positioned on the right side in the figure ejects a magenta ink and a yellow ink. Further, this combination is merely an example, and any combination of inks may be used. One ejection module may be configured to eject one kind of ink or three or more kinds of inks. Two ejection modules 300 do not necessarily eject the same number of kinds of inks. The ejection unit may be configured to include one ejection module 300 or three or more ejection modules. Further, in the example shown in FIGS. 3A and 3B, two ejection orifice arrays extending in the Y direction are formed for the ink of one color. The pressure chamber 12, the common supply channel 18 and the common collecting channel 19 are respectively formed for each of the plurality of ejection orifices 13 constituting each ejection orifice array.

An ink supply port and an ink collection port described below are formed on the rear surface (upper surface in FIG. 3B) side of the silicon substrate 310. The ink supply port supplies the ink from the ink supply channel 48 to a plurality of common supply channels 18, and the ink collection port collects the ink from a plurality of common collecting channels 19 to the ink collecting channel 49.

The ink supply port and the ink collection port here denote openings that supply and collect the ink during the ink circulation in the forward direction described below. That is, the ink is supplied from the ink supply port to each common supply channel 18 during the ink circulation in the forward direction, and the ink is collected from each common collecting channel 19 to the ink collection port at the same time. However, ink circulation in which the ink flows in the opposite direction is carried out in some cases. In this case, the ink is supplied from the ink collection port described above to the common collecting channel 19, and the ink is collected from the common supply channel 18 to the ink supply port at the same time.

As shown in FIG. 3A, the rear surface (upper surface in FIG. 3A) of the ejection module 300 is adhesively fixed to one surface (lower surface in FIG. 3A) of the first support member 4.

The ink supply channel 48 and the ink collecting channel 49 which penetrate from one surface into the other surface are formed in the first support member 4. One opening of the ink supply channel 48 communicates with the above-described ink supply port of the silicon substrate 310, and one opening of the ink collecting channel 49 communicates with the above-described ink collection port of the silicon substrate 310. Further, the ink supply channel 48 and the ink collecting channel 49 are provided independently for each kind of ink.

Further, a second support member 7 having an opening 7a (see FIG. 2) into which the ejection module 300 is inserted is adhesively fixed to one surface (upper surface in FIG. 3A) of the first support member 4.

The electrical wiring member 5 to be electrically connected to the ejection module 300 is held by the second support member 7. The electrical wiring member 5 is a member that applies an electric signal for ejecting the ink to the ejection module 300. A portion where the ejection module 300 and the electrical wiring member 5 are electrically connected to each other is sealed with a sealing material (not shown) so that the portion is protected from corrosion due to the ink or an external impact.

Further, the electrical contact substrate 6 is thermocompression-bonded to an end portion 5a (see FIG. 2) of the electrical wiring member 5 using an anisotropic conductive film (not shown) so that the electrical wiring member 5 and the electrical contact substrate 6 are electrically connected to each other. The electrical contact substrate 6 includes an external signal input terminal (not shown) for receiving the electric signal from the ink jet recording device 50.

Further, a joint member 8 (FIG. 3A) is provided between the first support member 4 and the circulation unit 54. A supply port 88 and a collection port 89 are formed in the joint member 8 for each kind of ink. The supply port 88 and the collection port 89 allow the ink supply channel 48 and the ink collecting channel 49 of the first support member 4 to communicate with a channel formed in the circulation unit 54. Further, in FIG. 3A, a supply port 88B and a collection port 89B correspond to the black ink, and a supply port 88C and a collection port 89C correspond to the cyan ink. Further, a supply port 88M and a collection port 89M correspond to the magenta ink, and a supply port 88Y and a collection port 89Y correspond to the yellow ink.

The openings in one end portion of the ink supply channel 48 and the ink collecting channel 49 of the first support member 4 have a small opening area according to the ink supply port and the ink collection port in the silicon substrate 310. Meanwhile, the openings in the other end portion of the ink supply channel 48 and the ink collecting channel 49 of the first support member have a shape enlarged to the same opening area as the large opening area of the join member 8 formed according to the channel of the circulation unit 54. With the above-described configuration, an increase in channel resistance to the ink collected from each collecting channel can be suppressed. However, the shapes of the openings in one end portion and the other end portion of the ink supply channel 48 and the ink collecting channel 49 are not limited to the above-described example.

In the recording head 1 with the above-described configuration, the ink supplied to the circulation unit 54 flows into the common supply channel 18 from the ink supply port of the ejection module 300 through the supply port 88 of the joint member 8 and the ink supply channel 48 of the first support member 4. Next, the ink flows into the pressure chamber 12 through the supply connection channel 323 from the common supply channel 18, and a part of the ink that has flowed into the pressure chamber is ejected from the ejection orifice 13 by driving the ejection element 15. The remaining ink that has not been ejected flows into the ink collecting channel 49 of the first support member 4 from the ink collection port through the collection connection channel 324 and the common collecting channel 19 from the pressure chamber 12. Further, the ink that has flowed into the ink collecting channel 49 flows and is collected into the circulation unit 54 through the collection port 89 of the joint member 8.

### <Constituent Element of Circulation Unit>

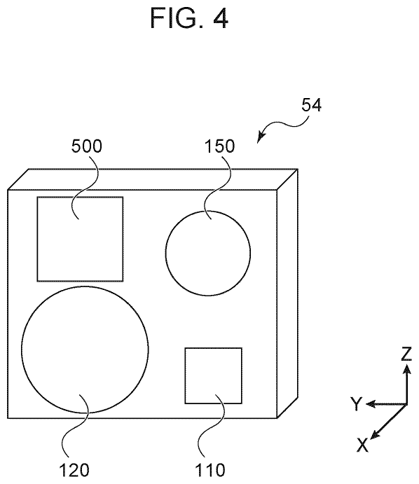

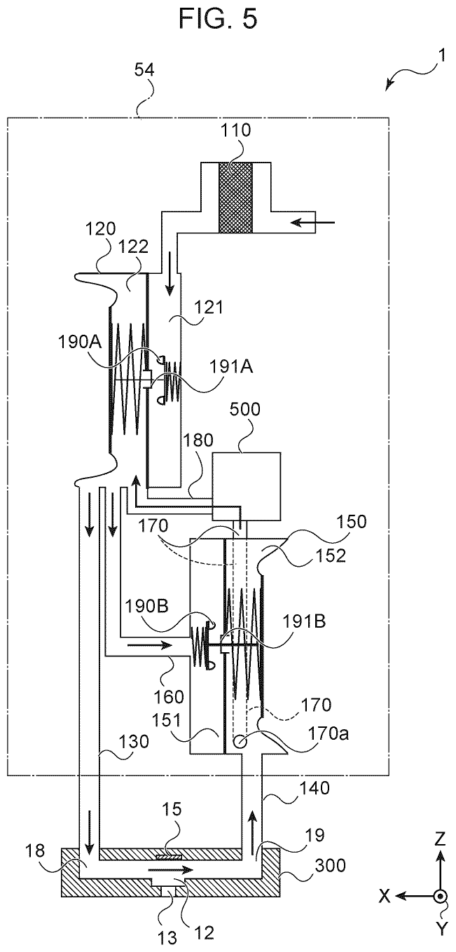

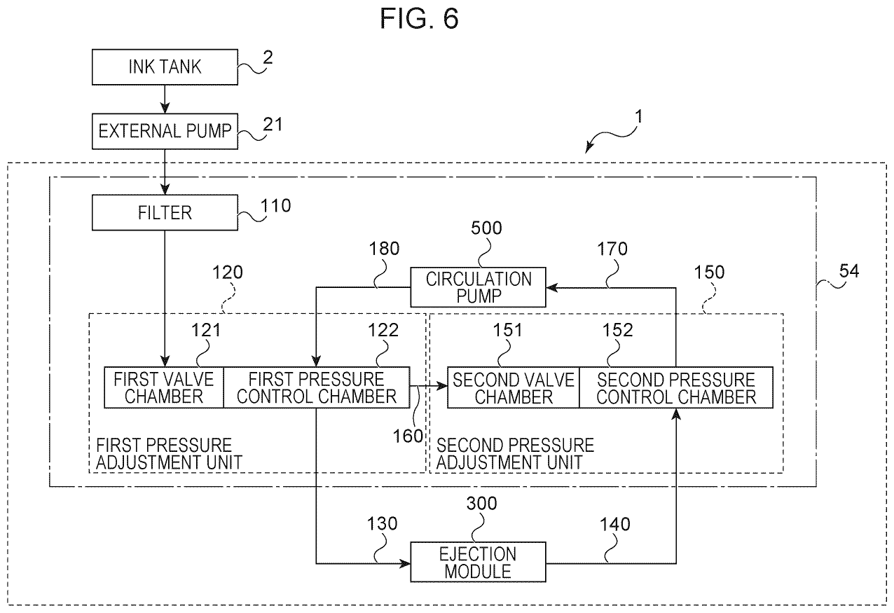

FIG. 4 is a schematic view showing the outer appearance of one circulation unit 54 corresponding to one kind of ink applied to the recording device according to the present embodiment. It is preferable that the circulation unit 54 include a filter 110, a first pressure adjustment unit 120 and a second pressure adjustment unit 150 in addition to the circulation pump 500. These constituent elements constitute the circulation channel connected to each channel as shown in FIGS. 5 and 6 and supplying and collecting the ink to the ejection module 300. It is preferable that the recording head 1 include the circulation pump 500 that allows the ink of the collecting channel to flow into the supply channel. That is, it is preferable that the recording head 1 having a circulation pump be fixedly supported by the carriage 60.

### <Circulation Channel in Recording Head>

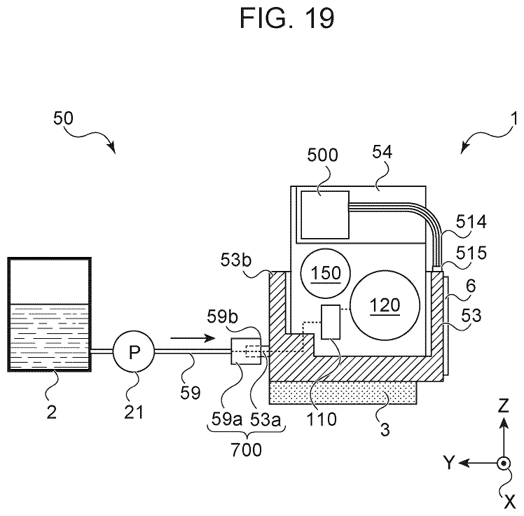

FIG. 5 is a longitudinal cross-sectional view schematically showing the circulation channel for one kind of ink (ink of one color), which is formed in the recording head 1. In order to more clearly describe the circulation channel, the relative position of each configuration (the first pressure adjustment unit 120, the second pressure adjustment unit 150, the circulation pump 500 or the like) in FIG. 5 is simplified. Therefore, the relative position of each configuration is different from the relative position in the configuration of FIG. 19 described below. Further, FIG. 6 is a block view schematically showing the circulation channel shown in FIG. 5. As shown in FIGS. 5 and 6, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured to have a control pressure that is relatively higher than that of the second pressure adjustment unit 150. In the present embodiment, the circulation of the ink in the circulation channel at a certain pressure is realized by using these two pressure adjustment units 120 and 150. Further, a configuration in which the ink flows in the pressure chamber 12 (ejection element 15) at a flow rate according to a difference in pressure between the first pressure adjustment unit 120 and the second pressure adjustment unit 150 is employed. Hereinafter, the circulation channel in the recording head 1 and the ink flow in the circulation channel will be described with reference to FIGS. 5 and 6. The arrows in each drawing indicate the direction in which the ink flows.

First, the connection state of each constituent element in the recording head 1 will be described.

The external pump 21 sending, to the recording head 1, the ink accommodated in the ink tank 2 (FIG. 6) provided outside the recording head 1 is connected to the circulation unit 54 through the ink supply tube 59 (FIG. 1A). The filter 110 is provided on the ink channel (inflow channel) positioned upstream of the circulation unit 54. The ink supply path (inflow channel) positioned downstream of the filter 110 is connected to the first valve chamber 121 of the first pressure adjustment unit 120. The first valve chamber 121 communicates with the first pressure control chamber 122 through a first communication port 191A that can be opened and closed by a first valve 190A shown in FIG. 5. The inflow channel is a channel that allows the ink in the ink tank 2 provided outside the recording head 1 to flow into the recording head 1 for supplying the pressure chamber 12.

The first pressure control chamber 122 is connected to a supply channel 130, a bypass channel 160 and a pump outlet channel 180 of the circulation pump 500. The supply channel 130 is connected to the common supply channel 18 through the above-described ink supply port provided in the ejection module 300. Further, the bypass channel 160 is connected to the second valve chamber 151 provided in the second pressure adjustment unit 150. The second valve chamber 151 communicates with the second pressure control chamber 152 through a second communication port 191B that is opened and closed by a second valve 190B shown in FIG. 5. FIGS. 5 and 6 show an example in which one end of the bypass channel 160 is connected to the first pressure control chamber 122 of the first pressure adjustment unit 120 and the other end of the bypass channel 160 is connected to the second valve chamber 151 of the second pressure adjustment unit 150. One end of the bypass channel 160 may be connected to the supply channel 130, and the other end of the bypass channel may be connected to the second valve chamber 151.

The second pressure control chamber 152 is connected to a collecting channel 140. The collecting channel 140 is connected to the common collecting channel 19 through the above-described ink collection port provided in the ejection module 300. Further, the second pressure control chamber 152 is connected to the circulation pump 500 through a pump inlet channel 170. In FIG. 5, the reference numeral 170a denotes an inflow port of the pump inlet channel 170.

Next, the flow of the ink in the recording head 1 with the above-described configuration will be described. As shown in FIG. 6, the ink accommodated in the ink tank 2 is pressurized by the external pump 21 provided in the ink jet recording device 50, and supplied to the circulation unit 54 of the recording head 1 as a positive pressure ink flow.

The ink supplied to the circulation unit 54 passes through the filter 110 to remove foreign substances such as dust, and air bubbles, and flows into the first valve chamber 121 provided in the first pressure adjustment unit 120. The pressure of the ink is decreased due to pressure loss when the ink passes through the filter 110, but the pressure of the ink at this stage is in a positive pressure state. Thereafter, the ink that has flowed into the first valve chamber 121 passes through the first communication port 191A and flows into the first pressure control chamber 122 when the first valve 190A is in an open state. The pressure state of the ink that has flowed into the first pressure control chamber 122 is switched from the positive pressure to the negative pressure due to the pressure loss when the ink passes through the first communication port 191A.

Here, the pore size (μm) of the filter 110 is preferably 1 μm or more to 10 μm or less. When the pore size thereof is less than 1 μm, particles having a particle diameter of 1 μm or less, such as a coloring material in the ink, are also collected, and thus stable supply of the ink cannot be sufficiently maintained in some cases. As a result, the image unevenness cannot be sufficiently suppressed in some cases. Meanwhile, when the pore size thereof is more than 10 μm, impurities, such as coarse particles in the ink, are difficult to remove. As a result, the above-described impurities are likely to enter the ink channel, and the ejection stability may not be sufficiently obtained. As a result, the image unevenness cannot be sufficiently suppressed in some cases.

From the viewpoint of suppressing local evaporation of the ink, the flow rate (circulation flow rate, mm/s) of the aqueous ink in the circulation path is preferably 10 mm/s or more to 30 mm/s or less. In addition, the circulation flow rate denotes the flow rate of the aqueous ink circulating the circulation path. Further, the circulation path denotes an area from the supply channel to the collecting channel. Further, in examples described below, the flow rate of the aqueous ink in the circulation path does not change even in the vicinity of a meniscus of the ejection orifice.

In a case where the circulation flow rate is less than 10 mm/s, the ejection stability is likely to be degraded due to the influence of local evaporation of the ink. Further, the circulation flow does not sufficiently reach the vicinity of the ejection orifice, and thus the solid components are likely to stay. As a result, the image unevenness in the intermittent ejection cannot be sufficiently suppressed in some cases.

Meanwhile, in a case where the flow rate is 30 mm/s or more, the ejection amount of the ink greatly changes when the ink is continuously ejected, and thus normal ejection is not carried out in some cases. As a result, the image unevenness in the intermittent ejection cannot be sufficiently suppressed in some cases. The circulation flow rate can be simply controlled by adjusting a difference between the pressure in the supply channel and the pressure in the collecting channel. In the examples described below, the circulation flow rate is adjusted by controlling the pressure in the first pressure control chamber 122 and the second pressure control chamber 152. Further, it is preferable that a difference between the circulation flow rate and the scanning speed be large in terms of the stirring effect of the ink in the vicinity of the ejection orifice using the high specific gravity particle in the present disclosure.

Next, the ink flow in the circulation path will be described. The circulation pump 500 is operated to send the ink sucked from the pump inlet channel 170 on the upstream side thereof to the pump outlet channel 180 on the downstream side thereof. Therefore, the ink supplied to the first pressure control chamber 122 by driving the pump flows into the supply channel 130 and the bypass channel 160 along with the ink sent from the pump outlet channel 180. As will be described below, in the present embodiment, a piezoelectric diaphragm pump having a piezoelectric element attached to a diaphragm as a driving source is used as a circulation pump capable of sending a liquid. The piezoelectric diaphragm pump is a pump that changes the volume in the pump chamber by inputting the driving voltage to the piezoelectric element and sends a liquid by allowing two check valves to alternately move using the pressure fluctuations.

The ink that has flowed into the supply channel 130 flows into the pressure chamber 12 through the common supply channel 18 from the ink supply port of the ejection module 300, and some of the ink is ejected from the ejection orifice 13 by driving (generating heat) the ejection element 15. The remaining ink that has not been used for ejection flows into the pressure chamber 12, passes through the common collecting channel 19, and flows into the collecting channel 140 connected to the ejection module 300. The ink that has flowed into the collecting channel 140 flows into the second pressure control chamber 152 of the second pressure adjustment unit 150.

Meanwhile, the ink that has flowed into the bypass channel 160 from the first pressure control chamber 122 flows into the second valve chamber 151, passes through the second communication port 191B, and flows into the second pressure control chamber 152. The ink that has flowed into the second pressure control chamber 152 via the bypass channel 160 and the ink collected from the collecting channel 140 are sucked into the circulation pump 500 via the pump inlet channel 170 by the drive of the circulation pump 500. Further, the ink sucked into the circulation pump 500 is sent to the pump outlet channel 180 and flows into the first pressure control chamber 122 again. Thereafter, the ink that has flowed into the second pressure control chamber 152 via the ejection module 300 from the first pressure control chamber 122 through the supply channel 130 and the ink that has flowed into the second pressure control chamber 152 via the bypass channel 160 flow into the circulation pump 500. Further, the ink is set to the first pressure control chamber 122 from the circulation pump 500. In this manner, the ink is circulated in the circulation path.

As described above, in the present embodiment, the ink can be circulated by the circulation pump 500 along the circulation path formed in the recording head 1. Therefore, thickening of the ink in the ejection module 300 and accumulation of precipitated components (solid components) of the ink, such as the coloring material, can be suppressed, and the fluidity of the ink in the ejection module 300 and the ejection characteristics in the ejection orifice can be maintained in a satisfactory state.

Since the circulation path of the present embodiment is configured to be formed only inside the recording head, the length of the circulation path can be significantly reduced as compared with a case where the ink is circulated between the recording head 1 and the ink tank 2 provided outside the recording head. Therefore, the circulation of the ink can be performed with a small circulation pump.

Further, only a channel that supplies the ink is provided as the connection channel between the recording head 1 and the ink tank 2. That is, a configuration that does not require a channel for collecting the ink from the recording head 1 to the ink tank 2 is employed. Therefore, only a tube for supplying the ink may be provided for connection between the ink tank 2 and the recording head 1, and a tube for collecting the ink is not required. Accordingly, the inside of the ink jet recording device 50 can be formed to have a simple configuration in which the number of tubes is reduced, and thus the entire device can be downsized.

Further, since the number of tubes is reduced, the ink pressure fluctuations caused by oscillation of tubes associated with the main scanning of the recording head 1 can be reduced. Further, the oscillation of tubes during the main scanning of the recording head 1 is a driving load on a carriage motor that drives the carriage 60. Therefore, the driving load on the carriage motor due to the reduction of the number of tubes is reduced, and the main scanning mechanism including the carriage motor and the like can be simplified. Further, since the collection of the ink from the recording head to the ink tank is not required, the external pump 21 can also be downsized. In this manner, according to the present embodiment, the downsizing of the ink jet recording device 50 and the cost reduction can be realized.

### <Pressure Adjustment Unit>

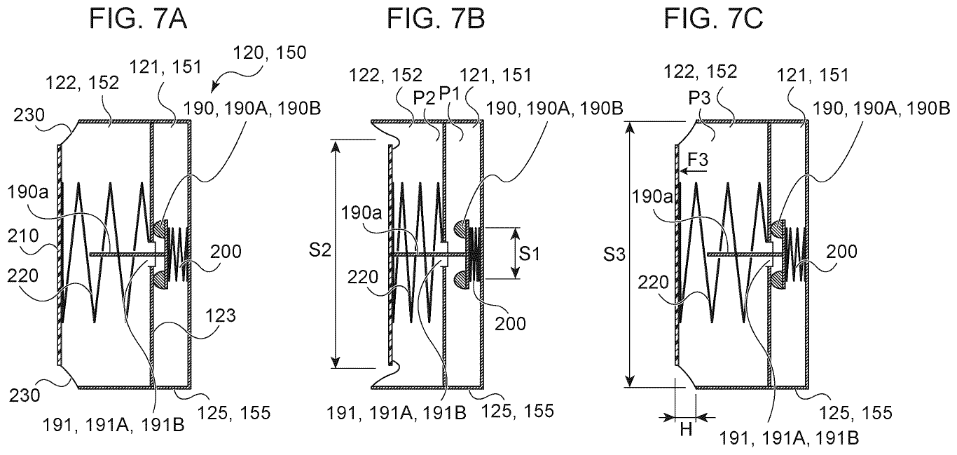

FIGS. 7A to 7C are views showing an example of the pressure adjustment unit. The configuration and the action of the pressure adjustment unit (the first pressure adjustment unit 120 and the second pressure adjustment unit 150) built in the recording head 1 described above will be described in more detail. The first pressure adjustment unit 120 and the second pressure adjustment unit 150 have substantially the same configuration. Therefore, hereinafter, the first pressure adjustment unit 120 will be described as an example, and in a case of the second pressure adjustment unit 150, the parts corresponding to the first pressure adjustment unit in FIGS. 7A to 7C will only be denoted by the reference numerals. In the case of the second pressure adjustment unit 150, the first valve chamber 121 described below will be replaced with the second valve chamber 151, and the first pressure control chamber 122 will be replaced with the second pressure control chamber 152.

The first pressure adjustment unit 120 includes the first valve chamber 121 and the first pressure control chamber 122 formed inside a cylindrical housing 125. The first valve chamber 121 and the first pressure control chamber 122 are separated from each other by a partition wall 123 provided inside the cylindrical housing 125. Here, the first valve chamber 121 communicates with the first pressure control chamber 122 through the communication port 191 formed in the partitional wall 123. The first valve chamber 121 is provided with a valve 190 that switches communication and blockage between the first valve chamber 121 and the first pressure control chamber 122 at the communication port 191. The valve 190 is held in a position facing the communication port 191 by a valve spring 200 and is configured to come into close contact with the partitional wall 123 due to the biasing force of the valve spring 200. The circulation of the ink in the communication port 191 is blocked when the valve 190 comes into close contact with the partitional wall 123. From the viewpoint of increasing the closeness of the valve 190 to the partitional wall 123, it is preferable that the contact portion between the valve 190 and the partitional wall 123 be formed of an elastic member. Further, a valve shaft 190a inserted into the communication port 191 projects from the central portion of the valve 190. The valve 190 is separated from the partitional wall 123 and the ink can be circulated in the communication port 191 by pressing the valve shaft 190a against the biasing force of the valve spring 200. Hereinafter, a state where the circulation of the ink in the communication port 191 is blocked by the valve 190 will be referred to as “closed state”, and a state where the ink can be circulated in the communication port 191 will be referred to as “open state”.

An opening portion of the cylindrical housing 125 is closed by a flexible member 230 and a pressure plate 210. The first pressure control chamber 122 is formed by the flexible member 230, the pressure plate 210, a peripheral wall of the housing 125 and the partitional wall 123. The pressure plate 210 is configured to be displaced as the flexible member 230 is displaced. The materials of the pressure plate 210 and the flexible member 230 are not particularly limited, and for example, the pressure plate 210 can be formed of a resin molded component and the flexible member 230 can be formed of a resin film. In this case, the pressure plate 210 can be fixed to the flexible member 230 by heat welding.

A pressure adjustment spring 220 (biasing member) is provided between the pressure plate 210 and the partitional wall 123. The pressure plate 210 and the flexible member 230 are biased in a direction in which the internal volume of the first pressure control chamber 122 expands due to the biasing force of the pressure adjustment spring 220 as shown in FIG. 7A.

Further, in a case where the pressure inside the first pressure control chamber 122 is decreased, the pressure plate 210 and the flexible member 230 are displaced in a direction in which the internal volume of the first pressure control chamber 122 is decreased against the pressure of the pressure adjustment spring 220. In addition, the pressure plate 210 comes into contact with the valve shaft 190a of the valve 190 when the internal volume of the first pressure control chamber 122 is decreased to a certain amount. Thereafter, in a case where the internal volume of the first pressure control chamber 122 is further decreased, the valve 190 moves along with the valve shaft 190a against the biasing force of the valve spring 200 and is separated from the partitional wall 123. In this manner, the communication port 191 enters an open state (state of FIG. 7B).

In the present embodiment, the connection inside the circulation path is set such that the pressure of the first valve chamber 121 when the communication port 191 enters an open state is higher than the pressure of the first pressure control chamber 122.

In this manner, the ink flows into the first pressure control chamber 122 from the first valve chamber 121 when the communication port 191 enters an open state. Due to this ink flow, the flexible member 230 and the pressure plate 210 are displaced in a direction in which the internal volume of the first pressure control chamber 122 is increased. As a result, the pressure plate 210 is separated from the valve shaft 190a of the valve 190, the valve 190 comes into close contact with the partition wall 123 due to the biasing force of the valve spring 200, and the communication port 191 enters a closed state (state of FIG. 7C).

In this manner, in the first pressure adjustment unit 120 according to the present embodiment, the ink flows into the first pressure control chamber 122 through the communication port 191 from the first valve chamber 121 when the pressure in the first pressure control chamber 122 decreases to a certain pressure or less (for example, the negative pressure is strong). In this manner, the first pressure adjustment unit 120 is configured such that the pressure of the first pressure control chamber 122 does not decrease any further. Therefore, the pressure of the first pressure control chamber 122 is controlled to be maintained in a certain range.

Next, the pressure of the first pressure control chamber 122 will be described in more detail. The flexible member 230 and the pressure plate 210 are displaced according to the pressure of the first pressure control chamber 122 as described above, the pressure plate 210 comes into contact with the valve shaft 190a, and the communication port 191 enters an open state (state of FIG. 7B). In this case, the relationship between forces acting on the pressure plate 210 is represented by Equation 1.

$$P 2 \times S 2 + F 2 + ( P 1 - P 2 ) \times S 1 + F 1 = 0 \qquad Equation 1$$

Further, P2 can be obtained by defining Equation 1 in the following manner.

$$P 2 = - ( F 1 + F 2 + P 1 \times S 1 ) / ( S 2 - S 1 ) \qquad Equation 2$$

P1: pressure (gauge pressure) of first valve chamber 121
P2: pressure (gauge pressure) of first pressure control chamber 122
F1: spring force of valve spring 200
F2: spring force of pressure adjustment spring 220
S1: pressure receiving area of valve 190
S2: pressure receiving area of pressure plate 210

Here, the spring force F1 of the valve spring 200 and the spring force F2 of the pressure adjustment spring 220 in a direction in which the valve 190 and the pressure plate 210 are pushed are set to be positive (in the left direction in FIGS. 7A to 7C). Further, the pressure P1 of the first valve chamber 121 and the pressure P2 of the first pressure control chamber 122 are set such that P1 satisfies a relationship of P1≥P2.

The pressure P2 of the first pressure control chamber 122 when the communication port 191 is in an open state is determined by Equation 2, and the ink flows into the first pressure control chamber 122 from the first valve chamber 121 due to the configuration that satisfies the relationship of P1≥P2 when the communication port 191 is in an open state. As a result, the pressure P2 of the first pressure control chamber 122 does not decrease any further, and the pressure P2 is maintained in a certain range.

Meanwhile, as shown in FIG. 7C, the pressure plate 210 is in a non-contact state with the valve shaft 190a, and the relationship between the forces acting on the pressure plate 210 when the communication port 191 is in a closed state is as shown in Equation 3.

$$P 3 \times S 3 + F 3 = 0 \qquad Equation 3$$

Here, P3 can be obtained by defining Equation 3 in the following manner.

$$P 3 = - F 3 / S 3 \qquad Equation 4$$

F3: spring force of pressure adjustment spring 220 when pressure plate 210 and valve shaft 190a are in non-contact state
P3: pressure (gauge pressure) of first pressure control chamber 122 when pressure plate 210 and valve shaft 190a are in non-contact state
S3: pressure receiving area of pressure plate 210 when pressure plate 210 and valve 190 are in non-contact state

Here, FIG. 7C shows a state where the pressure plate 210 and the flexible member 230 are displaced in the right direction of the figure up to the displacement limit. The pressure P3 of the first pressure control chamber 122, the spring force F3 of the pressure adjustment spring 220 and the pressure receiving area S3 of the pressure plate 210 are changed according to the displacement amount during the displacement of the pressure plate 210 and the flexible member 230 to the state of FIG. 7C. Specifically, when the pressure plate 210 and the flexible member 230 are in the right direction of FIGS. 7A to 7C with respect to those in FIG. 7C, the pressure receiving area S3 of the pressure plate 210 decreases, and the spring force F3 of the pressure adjustment spring 220 increases. As a result, the pressure P3 of the first pressure control chamber 122 decreases due to the relationship of Equation 4. Therefore, the pressure of the first pressure control chamber 122 gradually increases (that is, the negative pressure is weakened and becomes a value that approaches a positive pressure side) during transition of the state of FIG. 7B to the state of FIG. 7C based on Equations 2 and 4. That is, the pressure plate 210 and the flexible member 230 are gradually displaced in the left direction from the state where the communication port 191 is in an open state, and the pressure of the first pressure control chamber is gradually increased until the internal volume of the first pressure control chamber 122 finally reaches the displacement limit. That is, the negative pressure is weakened.

### <Circulation Pump>

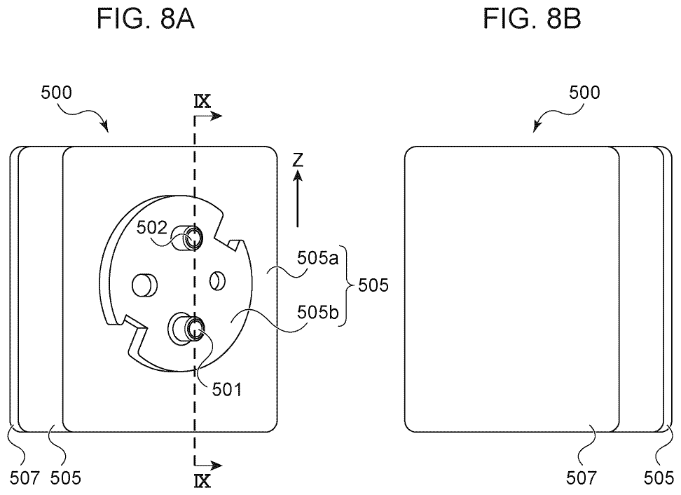

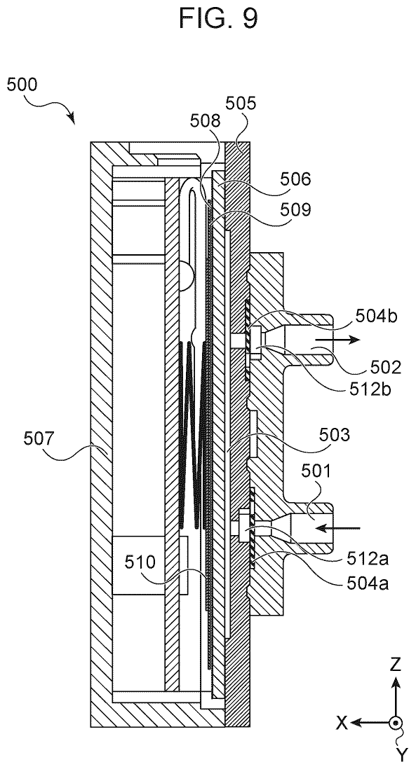

Next, the configuration and the operation of the circulation pump 500 built in the above-described recording head 1 will be described in detail with reference to FIGS. 8A to 9.

FIGS. 8A and 8B are perspective views showing the external appearance of the circulation pump 500. FIG. 8A is a perspective view showing the external appearance of the circulation pump 500 on the front side, and FIG. 8B is a perspective view showing the external appearance of the circulation pump 500 on the back side.

The outer shell of the circulation pump 500 is formed of a pump housing 505 and a cover 507 fixed to the pump housing 505. The pump housing 505 is formed of a housing main body 505a and a channel connection member 505b adhesively fixed to the outer surface of the housing main body 505a. The housing main body 505a and the channel connection member 505b are each provided with a pair of through holes communicating with each other and being provided at two different positions. A pair of through holes provided at one position form a pump supply hole 501, and a pair of through holes provided at the other position form a pump discharge hole 502. The pump supply hole 501 is connected to a pump inlet channel 170 connected to the second pressure control chamber 152, and the pump discharge hole 502 is connected to a pump outlet channel 180 connected to the first pressure control chamber 122. The ink supplied from the pump supply hole 501 passes through a pump chamber 503 described below (see FIG. 9) and is discharged from the pump discharge hole 502

FIG. 9 is a cross-sectional view taken alone the line IX-IX of the circulation pump 500 shown in FIG. 8A. A diaphragm 506 is bonded to the inner surface of the pump housing 505, and a pump chamber 503 is formed between the diaphragm 506 and a recess formed in the inner surface of the pump housing 505. The pump chamber 503 communicates with the pump supply hole 501 and the pump discharge hole 502 formed in the pump housing 505. Further, a check valve 504a is provided in a middle portion of the pump supply hole 501, and a check valve 504b is provided in a middle portion of the pump discharge hole 502. Specifically, the check valve 504a is disposed such that the check valve 504a can move to the left side in the figure in a space 512a partially formed in the middle portion of the pump supply hole 501. Further, the check valve 504b is disposed such that the check valve 504b can move to the right side in the figure in a space 512b partially formed in the middle portion of the pump discharge hole 502.

In a case where displacement of the diaphragm 506 leads to an increase in volume of the pump chamber 503 and, as a result, the pump chamber 503 is depressurized, the check valve 504a is separated from an opening of the pump supply hole 501 inside the space 512a (that is, the check valve 504a moves to the left side in the figure). When the check valve 504a is separated from the opening of the pump supply hole 501 inside the space 512a, the check valve 504a enters an open state so that the ink can be circulated in the pump supply hole 501. Further, in a case where displacement of the diaphragm 506 leads to a decrease in the volume of the pump chamber 503 and, as a result, the pump chamber 503 is pressurized, the check valve 504a comes into close contact with a wall surface in the periphery of the opening of the pump supply hole 501. As a result, the check valve 504a enters a closed state so that the circulation of the ink in the pump supply hole 501 is blocked.

Meanwhile, when the pump chamber 503 is depressurized, the check valve 504b comes into close contact with the wall surface in the periphery of the opening of the pump housing 505, and the check valve 504b enters a closed state so that the circulation of the ink in the pump discharge hole 502 is blocked. Further, when the pump chamber 503 is pressurized, the check valve 504b is separated from the opening of the pump housing 505 and moves to the space 512b side (that is, moves to the right side of the figure) so that the ink can be circulated in the pump discharge hole 502.

Each of the check valve 504a and the check valve 504b may be formed of a material that can be deformed according to the pressure inside the pump chamber 503, and examples of the material that can form each valve include an elastic member such as ethylene propylene rubber (EPDM) or an elastomer and a film or a thin plate such as polypropylene. However, the examples are not limited thereto.

As described above, the pump chamber 503 is formed by bonding the pump housing 505 and the diaphragm 506 to each other. Therefore, the pressure of the pump chamber 503 is changed due to the deformation of the diaphragm 506. For example, in a case where the diaphragm 506 is displaced to the pump housing 505 side (displaced to the right side in the figure) so that the volume of the pump chamber 503 is decreased, the pressure inside the pump chamber 503 is increased. In this manner, the check valve 504b disposed to face the pump discharge hole 502 enters an open state, and thus the ink of the pump chamber 503 is discharged. Here, since the check valve 504a disposed to face the pump supply hole 501 comes into close contact with the wall surface in the periphery of the pump supply hole 501, backflow of the ink from the pump chamber 503 to the pump supply hole 501 is suppressed.

Further, in a case where the diaphragm 506 is displaced in a direction in which the pump chamber 503 extends, the pressure of the pump chamber 503 is decreased. In this manner, the check valve 504a disposed to face the pump supply hole 501 enters an open state, the ink is supplied to the pump chamber 503. Here, the check valve 504b disposed in the pump discharge hole 502 comes into close contact with the wall surface in the periphery of the opening formed in the pump housing 505 so that the opening is blocked. Therefore, backflow of the ink from the pump discharge hole 502 to the pump chamber 503 is suppressed.

In this manner, in the circulation pump 500, the diaphragm 506 is deformed and changes the pressure inside the pump chamber 503 so that the ink is sucked and discharged. Here, when bubbles are mixed into the pump chamber 503, a change in pressure in the pump chamber 503 is decreased due to expansion and contraction of bubbles and thus the amount of liquid to be send is decreased even in a case where the diaphragm 506 is displaced. Therefore, the pump chamber 503 is disposed in parallel with gravity so that the bubbles mixed into the pump chamber 503 are likely to be collected above the pump chamber 503, and the pump discharge hole 502 is disposed above the center of the pump chamber 503. In this manner, discharging properties of the bubbles inside the pump can be improved, and the flow rate can be stabilized.

### <Ink Flow in Recording Head>

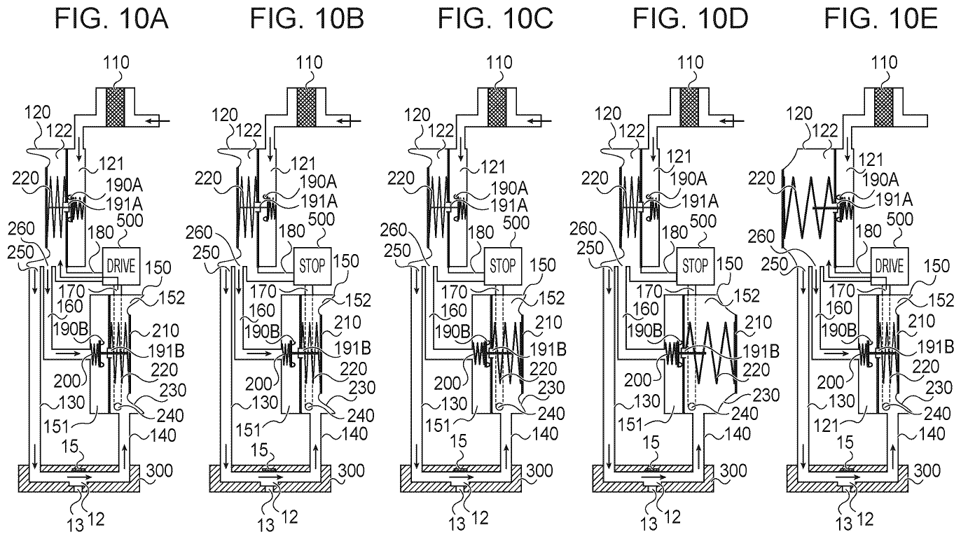

FIGS. 10A to 10E are views for describing the flow of ink in the recording head 1. The circulation of the ink in the recording head will be described with reference to FIGS. 10A to 10E. The relative positions of each configuration (the first pressure adjustment unit 120, the second pressure adjustment unit 150, the circulation pump 500 and the like) in FIGS. 10A to 10E are simplified in order to clearly describe the ink circulation path. Therefore, the relative positions of each configuration are different from the relative positions of the configurations of FIG. 19. FIG. 10A schematically shows the flow of ink in a case where a recording operation of recording an image by ejecting the ink from the ejection orifice 13 is performed. The arrows in the figure indicate the flow of ink. In the present embodiment, both the external pump 21 and the circulation pump 500 start driving during the recording operation. The external pump 21 and the circulation pump 500 may be driven regardless of the recording operation. Further, the external pump 21 and the circulation pump 500 are not necessarily driven in conjunction with each other and may be driven separately and independently.

The circulation pump 500 is in an ON state (driving state) during the recording operation, and the ink flowing out from the first pressure control chamber 122 flows into the supply channel 130 and the bypass channel 160. The ink flowing into the supply channel 130 passes through the ejection module 300, flows into the collecting channel 140, and is supplied to the second pressure control chamber 152.

Meanwhile, the ink that has flowed into the first pressure control chamber 122 and the bypass channel 160 flows into the second pressure control chamber 152 through the second valve chamber 151. The ink that has flowed into the second pressure control chamber 152 passes through the pump inlet channel 170, the circulation pump 500 and the pump outlet channel 180 and flows into the first pressure control chamber 122 again. Here, the control pressure due to the first valve chamber 121 is set to be higher than the control pressure of the first pressure control chamber 122 based on the relationship of Equation 2. Therefore, the ink inside the first pressure control chamber 122 is supplied to the ejection module 300 via the supply channel 130 again without flowing into the first valve chamber 121. The ink that has flowed into the ejection module 300 flows into the first pressure control chamber 122 again through the collecting channel 140, the second pressure control chamber 152, the pump inlet channel 170, the circulation pump 500 and the pump outlet channel 180. In this manner, the ink circulation is completed within the recording head 1.

In the ink circulation described above, the circulation amount (flow rate) of the ink in the ejection module 300 is determined by the differential pressure between the control pressure in the first pressure control chamber 122 and the control pressure in the second pressure control chamber 152. Further, the differential pressure is set to obtain the circulation amount that enables suppression of thickening the ink in the vicinity of the ejection orifice inside the ejection module 300. Further, the ink by the amount consumed during the recording is supplied to the first pressure control chamber 122 via the filter 110 and the first valve chamber 121 from the ink tank 2. The mechanism by which the consumed ink is supplied will be described in detail. The amount of ink in the circulation path is decreased by the amount of ink consumed during the recording, the pressure in the first pressure control chamber is reduced, and as a result, the amount of ink in the first pressure control chamber 122 is decreased. As the amount of ink in the first pressure control chamber 122 decreases, the internal volume of the first pressure control chamber 122 decreases. The first communication port 191A enters an open state due to the decrease in the internal volume of the first pressure control chamber 122 so that the ink is supplied from the first valve chamber 121 to the first pressure control chamber 122. A pressure loss occurs when the ink to be supplied passes through the first communication port 191A from the first valve chamber 121, the ink flows into the first pressure control chamber 122, and thus the state of the positive pressure ink is switched to a state of the negative pressure. Further, the pressure in the first pressure control chamber increases due to the flow of the ink into the first pressure control chamber 122 from the first valve chamber 121, the internal volume of the first pressure control chamber increases, and accordingly, the first communication port 191A enters a closed state. In this manner, the state of the first communication port 191A is continuously switched between the open state and the closed state according to the consumption of the ink. Further, in a case where the ink is not consumed, the first communication port 191A is maintained in the closed state.

FIG. 10B schematically shows the ink flow immediately after the recording operation is completed and the circulation pump 500 is in an OFF state (stopped state). When the recording operation is completed and the circulation pump 500 is turned off, both the pressure of the first pressure control chamber 122 and the pressure of the second pressure control chamber 152 are control pressures during the recording operation. Therefore, the ink moves as shown in FIG. 10B according to the differential pressure between the pressure of the first pressure control chamber 122 and the pressure of the second pressure control chamber 152. Specifically, the ink is supplied to the ejection module 300 via the supply channel 130 from the first pressure control chamber 122, and thereafter, the ink continues to flow into the second pressure control chamber 152 through the collecting channel 140. Further, the ink also continues to flow into the second pressure control chamber 152 through the bypass channel 160 and the second valve chamber 151 from the first pressure control chamber 122.

The amount of ink that has moved to the second pressure control chamber 152 from the first pressure control chamber 122 due to the flow of the ink described above is supplied to the first pressure control chamber 122 through the filter 110 and the first valve chamber 121 from the ink tank 2. Therefore, the internal volume of the first pressure control chamber 122 is maintained constant. When the internal volume of the first pressure control chamber is maintained constant based on the relationship of Equation 2, the spring force F1 of the valve spring 200, the spring force F2 of the pressure adjustment spring 220, the pressure receiving area S1 of the valve 190 and the pressure receiving area S2 of the pressure plate 210 are maintained constant. Therefore, the pressure of the first pressure control chamber 122 is determined according to a change in pressure (gauge pressure) P1 of the first valve chamber 121. Therefore, in a case where the pressure P1 of the first valve chamber 121 does not change, the pressure P2 of the first pressure control chamber 122 is maintained to be the same as the control pressure during the recording operation.

Meanwhile, the pressure of the second pressure control chamber 152 changes over time according to a change in internal volume associated with the inflow of the ink from the first pressure control chamber 122. Specifically, the pressure of the second pressure con troll chamber 152 changes according to Equation 2 during when the communication port 191 enters a closed state and the second valve chamber 151 and the second pressure control chamber 152 enter a non-communication state as shown in FIG. 10C from the state of FIG. 10B. Thereafter, the pressure plate 210 and the valve shaft 190a enter in a non-contact state, and the communication port 191 enters a closed state. Further, as shown in FIG. 10D, the ink flows into the second pressure control chamber 152 from the collecting channel 140. The pressure of the second pressure control chamber 152 changes according to Equation 4 during when the pressure plate 210 and the flexible member 230 are displaced due to the inflow of the ink and the internal volume of the second pressure control chamber 152 is maximized. That is, the pressure increases.

In the state shown in FIG. 10C, the flow of the ink into the second pressure control chamber 152 through the bypass channel 160 and the second valve chamber 151 from the first pressure control chamber 122 does not occur. Therefore, only the flow of the ink inside the first pressure control chamber 122 into the second pressure control chamber 152 through the collecting channel 140 after being supplied to the ejection module 300 via the supply channel 130 occurs.

As described above, the movement of the ink to the second pressure control chamber 152 from the first pressure control chamber 122 occurs in response to the differential pressure between the pressure inside the first pressure control chamber 122 and the pressure inside the second pressure control chamber 152.

Therefore, the movement of the ink is stopped when the pressure inside the second pressure control chamber 152 becomes equal to the pressure inside the first pressure control chamber 122.

Further, in the state where the pressure inside the second pressure control chamber 152 becomes equal to the pressure inside the first pressure control chamber 122, the second pressure control chamber 152 expands to the state shown in FIG. 10D. A storage portion capable of storing the ink is formed in the second pressure control chamber 152 in a case where the second pressure control chamber 152 has expanded as shown in FIG. 10D. The transition to the state in FIG. 10D from the stop of the circulation pump 500 occurs over a time of about 1 to 2 minutes even though the time varies depending on the shape and the size of the channel and the properties of the ink. The ink in the storage unit is supplied to the first pressure control chamber 122 by the circulation pump 500 when the circulation pump 500 is driven in the state where the ink is stored in the storage unit as shown in FIG. 10D. In this manner, the amount of the ink in the first pressure control chamber 122 increases as shown in FIG. 10E, and the flexible member 230 and the pressure plate 210 are displaced in the expansion direction. Further, in a case where the circulation pump 500 continues to be driven, the state inside the circulation path changes as shown in FIG. 10A.

In the description above, FIG. 10A has been described as an example during the recording operation, but the circulation of the ink may be carried out without performing the recording operation as described above. Even in this case, the ink flows as shown in FIGS. 10A to 10E according to the driving and stopping of the circulation pump 500.

As described above, in the present embodiment, an example in which the second communication port 191B in the second pressure adjustment unit 150 is in an open state when the circulation pump 500 is driven to circulate the ink and is in a closed state when the circulation of the ink is stopped, but the present disclosure is not limited thereto. The control pressure may be set such that the second communication port 191B in the second pressure adjustment unit 150 is in a closed state even when the circulation pump 500 is driven to circulate the ink. Hereinafter, this will be described in detail along with the description of the role of the bypass channel 160.

The bypass channel 160 connecting the first pressure adjustment unit 120 and the second pressure adjustment unit 150 is provided to prevent the ejection module 300 from being affected, for example, when the negative pressure generated in the circulation path becomes stronger than the predetermined value. Further, the bypass channel 160 is provided to supply the ink to the pressure chamber 12 from both sides of the supply channel 130 and the collecting channel 140.

First, the example in which the bypass channel 160 is provided to prevent the ejection module 300 from being affected when the negative pressure becomes stronger than the predetermined value will be described. For example, the characteristics (for example, the viscosity) of the ink may change due to a change in environmental temperature. When the viscosity of the ink changes, the pressure loss inside the circulation path also changes. For example, the amount of pressure loss inside the circulation path decreases when the viscosity of the ink decreases. As a result, the flow rate in the circulation pump 500 driven at a constant driving speed increases so that the flow rate of the ink flowing in the ejection module 300 increases. Meanwhile, since the ejection module 300 is maintained at a constant temperature by a temperature adjustment mechanism (not shown), the viscosity of the ink inside the ejection module 300 is maintained constant even when the environmental temperature changes. The negative pressure in the ejection module 300 increases due to the flow resistance as the flow rate of the ink flowing in the ejection module 300 increases while the viscosity of the ink in the ejection module 300 does not change. In this manner, when the negative pressure in the ejection module 300 becomes stronger than the predetermined value, the meniscus of the ejection orifice 13 is destroyed, external air is drawn into the circulation path, and as a result, normal ejection cannot be made in some cases. Further, even when the meniscus is not destroyed, the negative pressure of the pressure chamber 12 becomes stronger than the predetermined value and ejection of the ink is affected in some cases.

Therefore, in the present embodiment, the bypass channel 160 is formed inside the circulation path. When the bypass channel 160 is provided, since the ink also flows into the bypass channel 160 in a case where the negative pressure becomes stronger than the predetermined value, the pressure of the ejection module 300 can be maintained constant. Therefore, for example, the second communication port 191B in the second pressure adjustment unit 150 may be formed at a control pressure to maintain the closed state even in a case where the circulation pump 500 is driven. Further, in a case where the negative pressure becomes stronger than the predetermined value, the control pressure in the second pressure adjustment unit may be set such that the second communication port 191B in the second pressure adjustment unit 150 is in an open state. That is, the second communication port 191B may be in a closed state in a case where the circulation pump 500 is driven when the meniscus is not destroyed even due to a change in flow rate of the ink in the pump caused by a change in viscosity such as an environmental change.

Next, an example in which the bypass channel 160 is provided for supplying the ink to the pressure chamber 12 from both sides of the supply channel 130 and the collecting channel 140 will be described. The pressure fluctuations inside the circulation path may occur due to an ejection operation performed by the ejection element 15. The reason for this is that a force of drawing the ink to the pressure chamber is generated associated with the ejection operation.

Hereinafter, the point that the ink to be supplied to the pressure chamber 12 is supplied to both sides of the supply channel 130 and the collecting channel 140 in a case where high-duty recording is continued will be described. The definition of duty can change depending on various conditions. Here, as an example, an image recorded under a condition that one ink droplet having a volume of 4 pL per droplet is applied to a unit area of 1,200 dpi×1,200 dpi is considered to have a duty of 100%. The high-duty recording denotes, for example, recording performed with a duty of 100%.

When high-duty recording is continued, the amount of ink to flow into the second pressure control chamber 152 through the collecting channel 140 from the pressure chamber 12 decreases. Meanwhile, since the circulation pump 500 allows a constant amount of ink to flow out, the balance between inflow and outflow of the ink in the second pressure control chamber 152 is disrupted, the amount of ink in the second pressure control chamber 152 is reduced, the negative pressure in the second pressure control chamber 152 increases, and the second pressure control chamber 152 is contracted. In addition, the amount of ink to flow into the second pressure control chamber 152 via the bypass channel 160 is increased due to an increase in negative pressure in the second pressure control chamber 152, and thus the second pressure control chamber 152 is stabilized in a state where the outflow and the inflow are balanced. In this manner, as a result, the negative pressure in the second pressure control chamber 152 increases according to the duty. As described above, in the configuration in which the second communication port 191B is in a closed state when the circulation pump 500 is driven, the second communication port 191B enters an open state according to the duty, and the ink flows into the second pressure control chamber 152 from the bypass channel 160.

Further, in a case where recording with a higher duty is continuously performed, the amount of ink to flow into the second pressure control chamber 152 through the collecting channel 140 from the pressure chamber 12 decreases, but the amount the ink to flow into the second pressure control chamber 152 from the second communication port 191B through the bypass channel 160 increases. In a case where this state proceeds further, the amount of ink to flow into the second pressure control chamber 152 through the collecting channel 140 from the pressure chamber 12 reaches zero, and the entire ink to flow out from the circulation pump 500 flows in from the second communication port 191B. In a case where this state proceeds further, the ink flows back to the pressure chamber 12 through the collecting channel 140 from the second pressure control chamber 152. In this state, the ink that flows out to the circulation pump 500 from the second pressure control chamber 152 and the ink that flows out to the pressure chamber 12 flow into the second pressure control chamber 152 from the second communication port 191B through the bypass channel 160. In this case, the pressure chamber 12 is filled with the ink of the supply channel 130 and the ink of the collecting channel 140, and the ink is ejected.

The backflow of the ink occurring in a case of recording with a high duty is a phenomenon that occurs due to the presence of the bypass channel 160. Further, the example in which the second communication port 191B in the second pressure adjustment unit enters an open state in response to the backflow of the ink has been described above, but backflow of the ink even occurs in a state where the second communication port 191B in the second pressure adjustment unit is in an open state. Further, even in the configuration that the second pressure adjustment unit is not provided, backflow of the ink may occur due to the presence of the bypass channel 160.

### <Configuration of Ejection Unit>

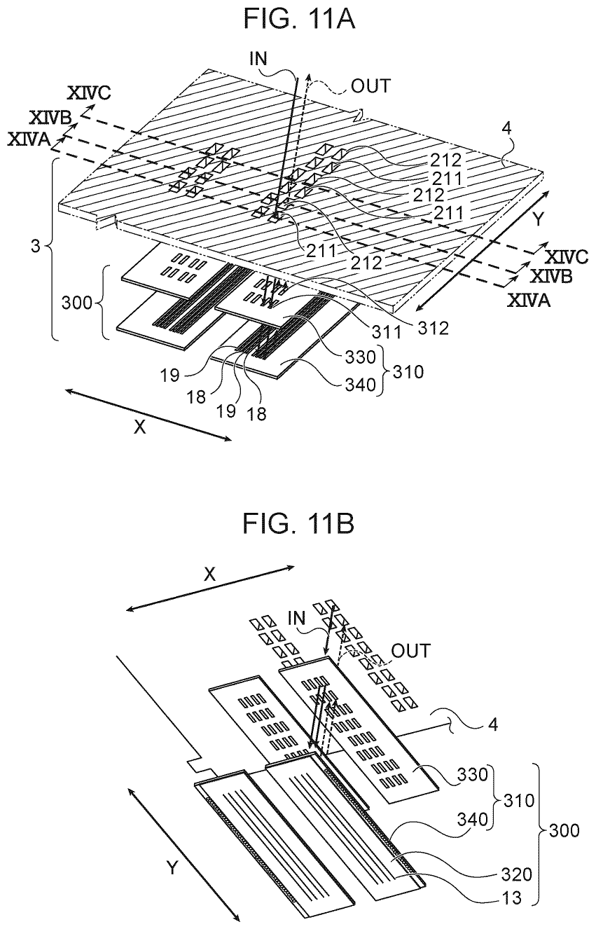

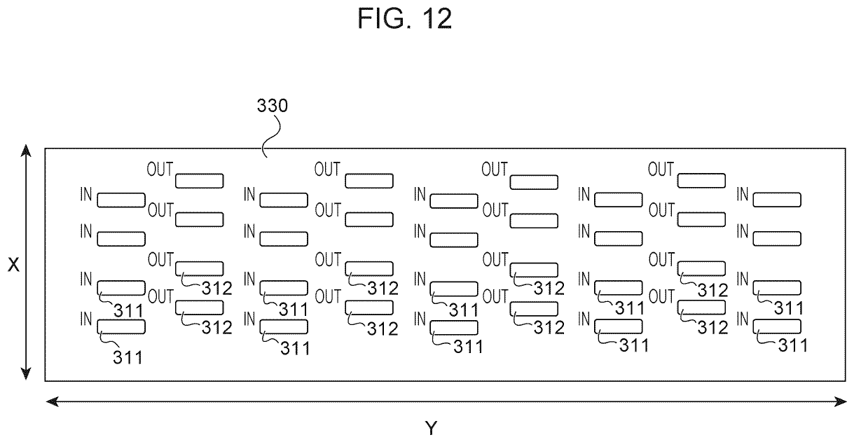

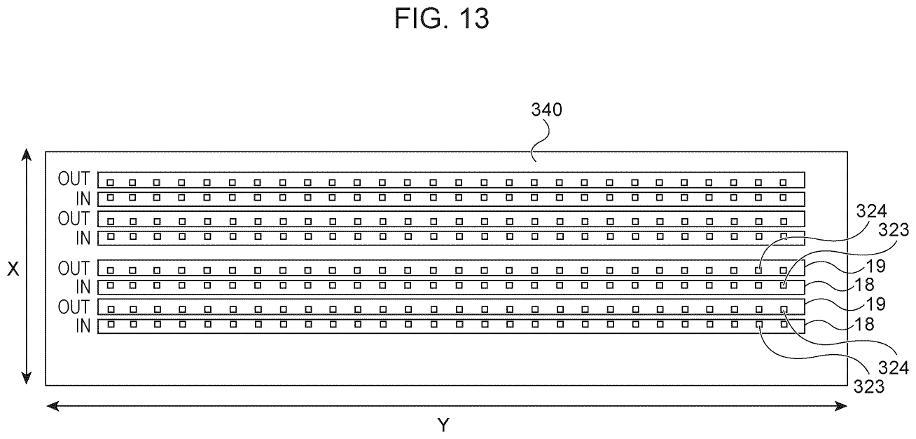

FIGS. 11A and 11B are schematic views showing the circulation path for the ink of one color in the ejection unit 3 according to the present embodiment. FIG. 11A is an exploded perspective view showing the ejection unit 3 as viewed from the first support member 4 side, and FIG. 11B is an exploded perspective view showing the ejection unit 3 as viewed from the ejection module 300 side. The arrows indicated with IN and OUT in FIGS. 11A and 11B show the flow of the ink, but only the flow of the ink of one color will be described, but the same applies to the flow of inks of other colors. Further, the description of the second support member 7 and the electrical wiring member 5 is omitted in FIGS. 11A and 11B, and also omitted in the following description of the configuration of the ejection unit. Further, the first support member 4 in FIG. 11A indicates the cross section taken along the line XIA-XIA of FIGS. 3A and 3B. The ejection module 300 includes an ejection element substrate 340 and an opening plate 330. FIG. 12 is a view showing the opening plate 330, and FIG. 13 is a view showing an example of the ejection element substrate 340.

The ink is supplied to the ejection unit 3 through the joint member 8 (see FIG. 3A) from the circulation unit 54. The path of the ink after passing through the joint member 8 until returning to the joint member 8 will be described. The description of the joint member 8 will be omitted in the following drawings.

The ejection module 300 includes the ejection element substrate 340 and the opening plate 330 that are formed into the silicon substrate 310 and further includes the ejection orifice forming member 320. The ejection element substrate 340, the opening plate 330, the ejection orifice forming member 320 are formed into the ejection module 300 by being bonded to each other in an overlapping manner such that the channels of each ink communicate with each other, and are supported by the first support member 4.

The ejection unit 3 is formed by the ejection module 300 being supported by the first support member 4. The ejection element substrate 340 includes the ejection orifice forming member 320, the ejection orifice forming member 320 includes a plurality of ejection orifice arrays in which a plurality of ejection orifices 13 form arrays, and some of the ink supplied through the ink channel inside the ejection module 300 is ejected from the ejection orifice 13. The ink that has not been ejected is collected through the ink channel inside the ejection module 300.

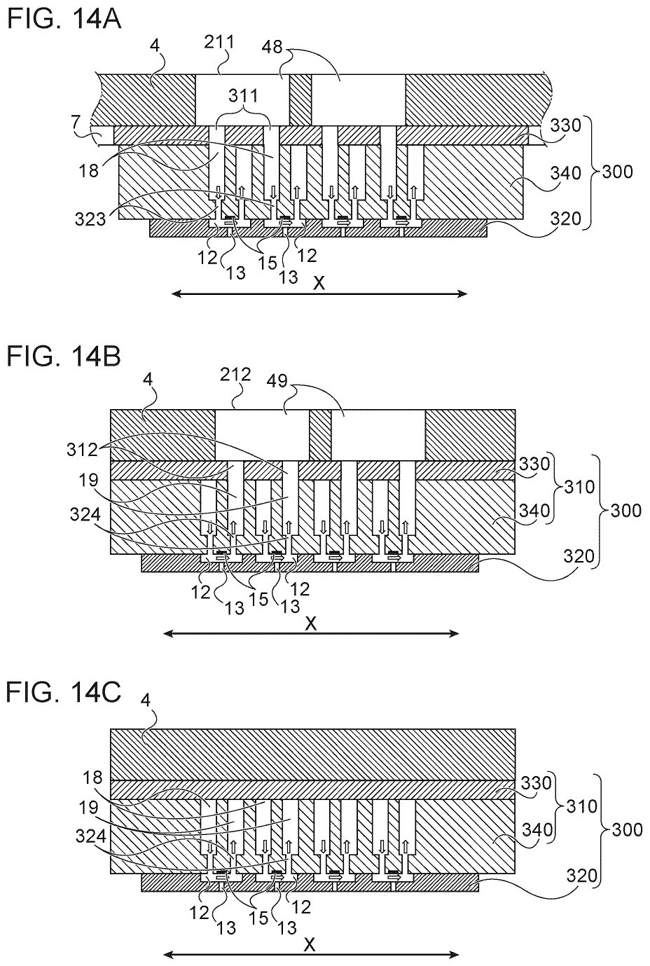

As shown in FIGS. 11A to 12, the opening plate 330 includes a plurality of arranged ink supply ports 311 and a plurality of arranged ink collection ports 312. As shown in FIGS. 13 to 14C, the ejection element substrate 340 includes a plurality of arranged supply connection channels 323 and a plurality of arranged collection connection channels 324. Further, the ejection element substrate 340 includes the common supply channels 18 communicating with the plurality of supply connection channels 323 and the common collecting channels 19 communicating the plurality of collection connection channels 324. The ink channel inside the ejection unit 3 is formed by allowing the ink supply channel 48 and the ink collecting channel 49 (see FIG. 3) provided in the first support member 4 and the channel provided in the ejection module 300 to communicate with each other. A support member supply port 211 is a cross section opening forming the ink supply channel 48, and a support member collection port 212 is a cross section opening forming the ink collecting channel 49.

The ink supplied to the ejection unit 3 is supplied to the ink supply channel 48 (see FIG. 3A) of the first support member 4 from the circulation unit 54 (see FIG. 3A) side. The ink flowing through the support member supply port 211 inside the ink supply channel 48 is supplied to the common supply channel 18 of the ejection element substrate 340 through the ink supply channel 48 (see FIG. 3A) and the ink supply port 311 of the opening plate 330, and enters the supply connection channel 323. The channel up to here is the supply-side channel. Thereafter, the ink flows into the collection connection channel 324 of the collection-side channel through the pressure chamber 12 (see FIG. 3B) of the ejection orifice forming member 320. The flow of the ink in the pressure chamber 12 will be described in detail below.

In the collection-side channel, the ink that has entered the collection connection channel 324 flows into the common collecting channel 19. Thereafter, the ink flows into the ink collecting channel 49 of the first support member 4 through the ink collection port 312 of the opening plate 330 from the common collecting channel 19 and is collected in the circulation unit 54 through the support member collection port 212.

The region of the opening plate 330 where the ink supply port 311 and the ink collection port 312 are not present corresponds to a region for partitioning the support member supply port 211 and the support member collection port 212 in the first support member 4. Further, the first support member 4 in the region also does not have an opening. Such a region is used as a bonding region in a case where the ejection module 300 and the first support member 4 are bonded to each other.

In the opening plate 330 shown in FIG. 12, a plurality of opening arrays arranged in the X direction are also provided in a plurality of arrays in the Y direction, and openings for supply (IN) and openings for collection (OUT) are alternately arranged in the Y direction such that the openings for supply and the openings for collection are shifted by half a pitch in the X direction. In the ejection element substrate 340 shown in FIG. 13, the common supply channels 18 communicating with a plurality of supply connection channels 323 arranged in the Y direction and the common collecting channels 19 communicating with a plurality of collection connection channels 324 arranged in the Y direction are alternately arranged in the X direction. The common supply channels 18 and the common collecting channels 19 are separated for each kind of ink, and the number of the common supply channels 18 and the common collecting channels 19 to be arranged is determined according to the number of ejection orifice arrays of each color. Further, the number of supply connection channels 323 and the collection connection channel 324 to be arranged corresponds to the number of ejection orifices 13. The number of supply connection channels 323 and the collection connection channels 324 and the number of ejection orifices 13 are not necessarily one-to-one correspondence, and one supply connection channel 323 and one collection connection channel 324 may correspond to a plurality of ejection orifices 13.

The opening plate 330 and the ejection element substrate 340 are formed into the ejection module 300 by being bonded to each other in an overlapping manner to communicate with channels of each color, and an ink channel including the supply channel and the collecting channel is formed by being supported by the first support member 4.

FIGS. 14A to 14C are cross-sectional views showing the ink flow at different portions of the ejection unit 3. FIG. 14A shows a cross section taken alone the line XIVA-XIVA of FIG. 11A, which is the cross section of a portion where the ink supply channel 48 and the ink supply port 311 in the ejection unit 3 communicate with each other. Further, FIG. 14B shows a cross section taken alone the line XIVB-XIVB of FIG. 11A, which is the cross section of a portion where the ink collecting channel 49 and the ink collection port 312 in the ejection unit 3 communicate with each other. FIG. 14C shows a cross section taken alone the line XIVC-XIVC of FIG. 11A, which is the cross section of a portion where the ink supply port 311 and the ink collection port 312 do not communicate with the channel of the first support member 4.

In the supply channel that supplies the ink, the ink is supplied from a portion where the ink supply channel 48 of the first support member 4 and the ink supply port 311 of the opening plate 330 communicate with each other in an overlapping manner as shown in FIG. 14A. Further, in the collecting channel that collects the ink, the ink is collected from a portion where the ink collecting channel 49 of the first support member 4 and the ink collection port 312 of the opening plate 330 communicate with each other in an overlapping manner as shown in FIG. 14B. Further, the ejection unit 3 has some regions where openings are not provided in the opening plate 330 as shown in FIG. 14C. In such regions, the supply and the collection of ink are not carried out between the ejection element substrate 340 and the first support member 4. The supply of ink is carried out in a region where the ink supply port 311 is provided as shown in FIG. 14A, and the collection of ink is carried out in a region where the ink collection port 312 is provided as shown in FIG. 14B. In the present embodiment, a configuration using the opening plate 330 has been described as an example, but a configuration in which the opening plate 330 is not used may be employed. For example, a configuration in which channels corresponding to the ink supply channel 48 and the ink collecting channel 49 are formed in the first support member and the ejection element substrate 340 is bonded to the first support member 4 may be employed.

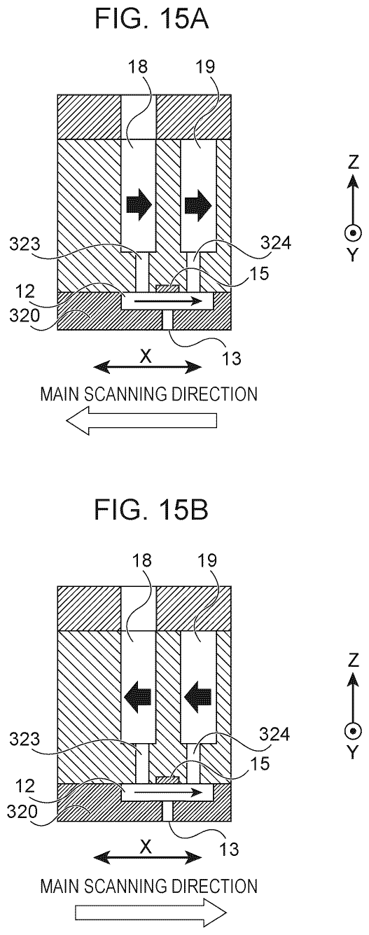

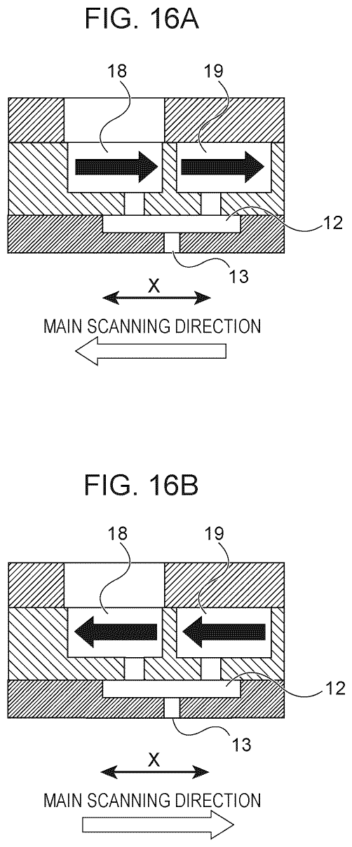

FIGS. 15A and 15B are cross-sectional views showing an example of the vicinity of the ejection orifice 13 in the ejection module 300, and FIGS. 16A and 16B are cross-sectional views showing an ejection module having a configuration in which the common supply channel 18 and the common collecting channel 19 are expanded in the X direction. The thick arrows shown in the common supply channel 18 and the common collecting channel 19 of FIGS. 15A to 16B indicate oscillation of the ink in the form in which the serial type ink jet recording device 50 is used. The ink supplied to the pressure chamber 12 through the common supply channel 18 and the supply connection channel 323 is ejected from the ejection orifice 13 by drying the ejection element 15. In a case where the ejection element 15 is not driven, the ink is collected into the common collecting channel 19 through the collection connection channel 324, which is a collecting channel, from the pressure chamber 12.

In a case where the ink circulated as described above is ejected in the form in which the serial type ink jet recording device 50 is used, the ejection of ink is considerably affected by oscillation of ink in the ink channel due to the main scanning of the recording head 1. The oscillation of ink has an effect of suppressing degradation of the ejection characteristics as described above, but large oscillation may conversely affect ejection of the ink. Specifically, the influence of oscillation of the ink in the ink channel may appear as a difference in amount of the ink to be ejected or a shift in the ejection direction. As shown in FIGS. 16A and 16B, in a case where the common supply channel 18 and the common collecting channel 19 have a wide cross-sectional shape in the X direction which is the main scanning direction, the ink in the common supply channel 18 and the common collecting channel 19 is likely to be subjected to the inertial force in the main scanning direction and thus undergoes large oscillation. As a result, the oscillation of ink may affect the ejection of ink from the ejection orifice 13. Further, in a case where the common supply channel 18 and the common collecting channel 19 are expanded in the X direction, the distance between colors increases, and the recording efficiency is reduced.

Therefore, both the common supply channel 18 and the common collecting channel 19 according to the present embodiment extend in the Y direction in the cross section shown in FIGS. 15A and 15B, but are configured to also extend in the Z direction perpendicular to the X direction which is the main scanning direction. With such a configuration, the width of each channel in the main scanning direction of the common supply channel 18 and the common collecting channel 19 can be reduced. When the width of each channel of the common supply channel 18 and the common collecting channel 19 in the main scanning direction is reduced, oscillation of ink due to the inertial force (thick black arrows in the figures) acting on the ink in the common supply channel 18 and the common collecting channel 19 during main scanning, which is on a side opposite to the main scanning direction, is reduced. In this manner, the influence of the oscillation of ink on the ejection of ink can be suppressed. Further, the cross-sectional area is increased and the channel pressure loss is reduced by allowing the common supply channel 18 and the common collecting channel 19 to extend in the Z direction.

As described above, the common supply channel 18 and the common collecting channel 19 are configured to reduce the oscillation of ink in the common supply channel 18 and the common collecting channel 19 during main scanning by reducing the width of each channel of the common supply channel 18 and the common collecting channel 19 in the main scanning direction, but this does not indicate that the oscillation disappears. Therefore, in order to suppress occurrence of a difference in ejection for each kind of ink, which may occur even due to reduced oscillation, the common supply channel 18 and the common collecting channel 19 in the present embodiment are configured to be disposed at positions where the common supply channel 18 and the common collecting channel 19 overlap each other in the X direction.

In the present embodiment, the supply connection channel 323 and the collection connection channel 324 are provided in correspondence with the ejection orifice 13, and have a correspondence relationship in which the supply connection channel 323 and the collection connection channel 324 are disposed side by side in a state of sandwiching the ejection orifice 13 in the X direction as described above. Therefore, a portion where the common supply channel 18 and the common collecting channel 19 do not overlap in the X direction is present, and the flow and ejection of the ink of the pressure chamber 12 in the X direction are affected in a case where the correspondence relationship between the supply connection channel 323 and the collection connection channel 324 in the X direction is disrupted. The ejection of ink for each ejection orifice is affected due to the influence of oscillation of ink.

Therefore, when the common supply channel 18 and the common collecting channel 19 are disposed at overlapping positions in the X direction, oscillations of ink in the common supply channel 18 and the common collecting channel 19 during main scanning are substantially the same as each other at any position in the Y direction where the ejection orifice 13 are arranged. As a result, the pressure difference occurring in the pressure chamber 12 between the common supply channel 18 side and the common collecting channel 19 side does not vary greatly, and thus ejection of the ink can be stably carried out.

Further, the recording head that circulates the ink may be configured such that the channel for supplying the ink to the recording head and the channel for collecting the ink are formed to be the same as each other, but the common supply channel 18 and the common collecting channel 19 are formed as separate channels in the present embodiment. Further, the supply connection channel 323 and the pressure chamber 12 communicate with each other and the pressure chamber 12 and the collection connection channel 324 communicate with each other so that the ink is ejected from the ejection orifice 13 of the pressure chamber 13. That is, the pressure chamber 12 serving as a path connecting the supply connection channel 323 and the collection connection channel 324 is configured to have the ejection orifice 13. Therefore, the ink flows from the supply connection channel 323 side to the collection connection channel 324 side in the pressure chamber 12, and the ink inside the pressure chamber is efficiently circulated. Since the ink inside the pressure chamber 12 is efficiently circulated, the ink in the pressure chamber 12 that is easily affected by evaporation of the ink from the ejection orifice 13 can be maintained in a fresh state.

Further, two channels of the common supply channel 18 and the common collecting channel 19 communicate with the pressure chamber 12, and thus the ink can also be supplied from both the channels in a case where the ink is required to be ejected at a high flow rate. That is, the configuration of the present embodiment has an advantage that the ink can be efficiently circulated and can also be ejected at a high flow rate, as compared with a configuration in which the supply and collection of ink are carried out by using only one channel.

Further, in a case where the common supply channel 18 and the common collecting channel 19 are disposed at positions close to each other in the X direction, both the channels are unlikely to be affected by oscillation of the ink. The distance between the channels may be desirably 75 μm or more to 100 μm or less.

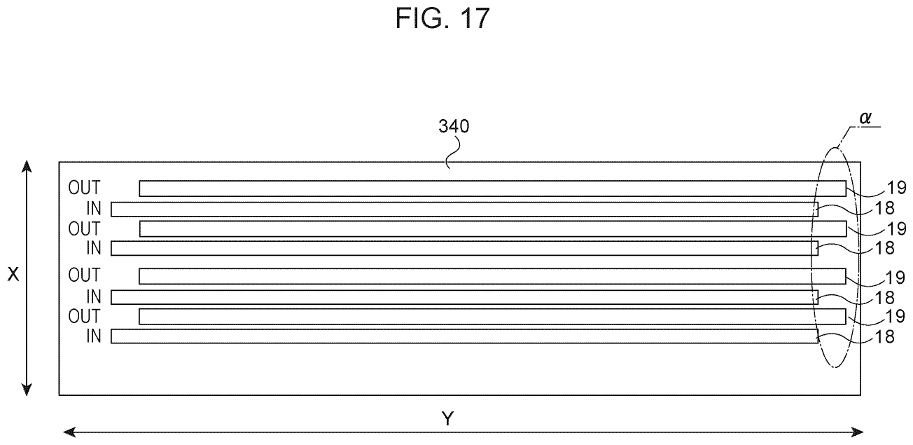

FIG. 17 is a view showing another example of the ejection element substrate 340. The description of the supply connection channel 323 and the collection connection channel 324 is omitted in FIG. 17. Since the ink that has received thermal energy from the ejection element 15 in the pressure chamber 12 flows into the common collecting channel 19, the ink at a temperature relatively higher than the temperature of the ink in the common supply channel 18 flows. Here, a portion of the ejection element substrate 340 in the X direction has a portion where only the common collecting channel 19 is present, such as a portion a surrounded by the dashed line of FIG. 17. In this case, there is a possibility that the temperature locally increases in this portion, and temperature unevenness occurs in the ejection module 300 and affects the ejection of the ink.

The ink at a temperature relatively lower than the temperature of the ink in the common collecting channel 19 flows in the common supply channel 18. Therefore, in a case where the common supply channel 18 and the common collecting channel 19 are adjacent to each other, the temperature in the common supply channel 18 and the temperature in the common collecting channel 19 cancel out each other in the vicinity thereof, and thus an increase in temperature is suppressed. Accordingly, it is preferable that the common supply channel 18 and the common collecting channel 19 be present with substantially the same length at overlapping positions in the X direction so that these channels are adjacent to each other.

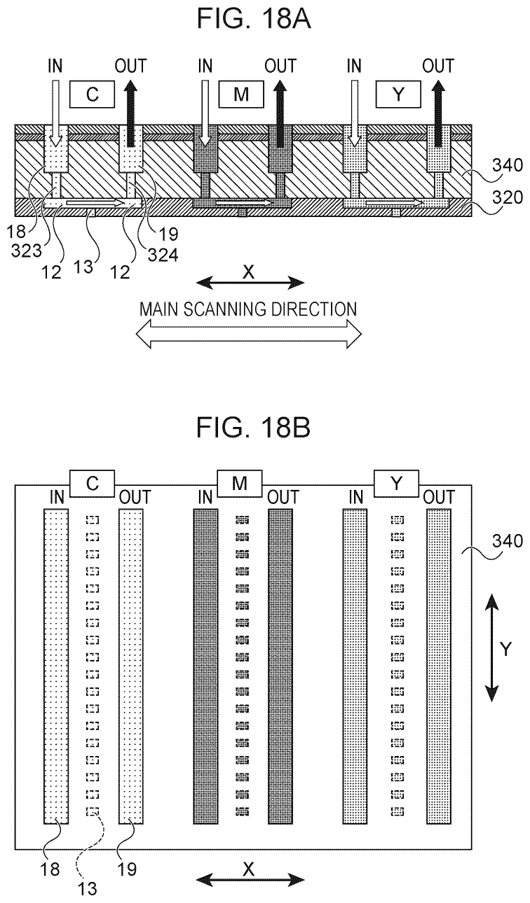

FIGS. 18A and 18B are views showing the configuration of channels of the recording head 1 corresponding to the inks of three colors, which are cyan (C), magenta (M) and yellow (Y). The recording head 1 is provided with circulation paths for each type of ink as shown in FIG. 18A. The pressure chamber 12 is provided in the X direction which is the main scanning direction of the recording head 1. Further, as shown in FIG. 18B, the common supply channel 18 and the common collecting channel 19 are provided along the ejection orifice array in which the ejection orifices 13 are arranged, and the common supply channel 18 and the common collecting channel 19 are provided extending in the Y direction to sandwich the ejection orifice array.

### <Connection Between Main Body Portion and Recording Head>

FIG. 19 is a schematic configuration view more specifically showing the connection state between the ink tank 2, the external pump 21 and the recording head 1 which are provided in the main body portion of the ink jet recording device according to the present embodiment and disposition of the circulation pump and the like. The ink jet recording device 50 according to the present embodiment is configured such that only the recording head 1 can be simply replaced when failure occurs in the recording head 1. Specifically, the ink jet recording device 50 includes a liquid connection unit 700 that can simply perform connection and disconnection between the ink supply tube 59 connected to the external pump 21 and the recording head 1. In this manner, only the recording head 1 can be simply attached to and detached from the ink jet recording device 50.

The liquid connection unit 700 includes a liquid connector insertion port 53a protruding from the head housing 53 of the recording head 1 and a cylindrical liquid connector 59a into which the liquid connector insertion port 53a can be inserted, as shown in FIG. 19. The liquid connector insertion port 53a is fluidly connected to the ink supply channel (inflow channel) formed inside the recording head 1 and is connected to the first pressure adjustment unit 120 through the above-described filter 110. Further, the liquid connector 59a is provided at the tip of the ink supply tube 59 connected to the external pump 21 that pressurizes and supplies the ink in the ink tank 2 to the recording head 1.

The recording head 1 shown in FIG. 19 can be easily attached to and detached from the ink jet recording device and also can be easily replaced by the liquid connection unit 700 as described above. Here, in a case where sealing properties between the liquid connector insertion port 53a and the liquid connector 59a are degraded, the ink pressurized and supplied by the external pump 21 may leak from the liquid connection unit 700. Further, failure may occur in the electrical system in a case where the ink that has leaked adheres to the circulation pump 500 or the like. Therefore, the circulation pump and the like are disposed as described below in the present embodiment.

### <Disposition of Circulation Pump and the Like>

As shown in FIG. 19, in the present embodiment, the circulation pump 500 is disposed above the liquid connection unit 700 in the gravity direction in order to prevent the ink leaked from the liquid connection unit 700 from adhering to the circulation pump 500. That is, the circulation pump 500 is disposed above the liquid connector insertion port 53a, which is the introduction port of the liquid in the recording head 1, in the gravity direction. In addition, the circulation pump 500 is disposed at a position that is not in contact with the members constituting the liquid connection unit 700. In this manner, since the ink flows on a lower side in the gravity direction or the horizontal direction which is the opening direction of the liquid connector 59a even when the ink has leaked from the liquid connection unit 700, it is possible to suppress the ink from reaching the circulation pump 500 provided on an upper side in the gravity direction. Further, the circulation pump 500 is disposed at a position spaced from the liquid connection unit 700, and thus the possibility that the ink reaches the circulation pump 500 through the members is also reduced.

Further, an electrical connection unit 515 that electrically connects the circulation pump 500 and the electrical contact substrate 6 via the flexible wiring member 514 is provided above the liquid connection unit 700 in the gravity direction. Therefore, the possibility of electrical troubles caused by the ink from the liquid connection unit 700 can be reduced.

Further, since a wall portion 52b of the head housing 53 is provided in the present embodiment, even when the ink is ejected from the opening 59b of the liquid connection unit 700, the flow of the ink is blocked, and the possibility of the ink reaching the circulation pump 500 and the electrical connection unit 515 can be reduced.

### (Heating Step)

A recording method of the present disclosure may include a step of heating a recording medium to which the ink has been applied (heat treatment). When the recording medium to which the ink has been applied is heated, drying of the recording medium can be promoted, or the strength of the image can be increased.

Examples of a method of heating the recording medium include a known temperature increasing method of using a heater or the like, an air blowing method of blowing air using a dryer or the like, and a heating method of combining these methods. Examples of the heating method include the temperature increasing method, the air blowing method, and the method of combining these methods described above. Examples of a method performing the heat treatment include a method of applying heat from a side of the recording medium (rear surface) opposite to the recording surface (surface onto which the ink has been applied) using a heater or the like, a method of applying warm air or hot air to the recording surface of the recording medium, and a method of heating the recording surface or the rear surface using an infrared heater. Further, a plurality of these methods may be used in combination.

From the viewpoint of enhancing the abrasion resistance of an image, the heating temperature of the recording medium to which the ink and a reaction solution have been applied is preferably 50° C. or higher to 90° C. or lower. The heating temperature of the recording medium to which the ink has been applied may be read by a sensor installed in a position corresponding to a heating unit of the recording device or may be determined based on the relationship between the temperature of the recording medium and the amount of heat determined according to the kinds of the ink and the recording medium.

### (Recording Medium)

In the recording method and the recording device of the present disclosure, it is preferable to use a non-absorbing recording medium (low to non-absorbing recording medium). The low to non-absorbing recording medium is a recording medium in which the water absorption amount from the start of contact to 30 msec^{1/2} is 0 mL/m² or more to 10 mL/m² or less in the Bristow method described in No. 51 “Paper and Paperboard, Liquid Absorbency Test Method” of Paper and Pulp Test Method by JAPAN TAPPI. In the present disclosure, the recording medium satisfying the conditions for the water absorption amount is defined as “low to non-absorbing recording medium”. A recording medium (glossy paper, mat paper or the like) for ink jet recording, which includes a coating layer (ink receiving layer) formed of inorganic particles or plain paper having no coating layer is “absorbing recording medium” having a water absorption amount of more than 10 mL/m².

Examples of the low to non-absorbing recording medium include a plastic film, a recording medium in which a plastic film is adhered to the recording surface of a base material, and a recording medium in which a resin coating layer is provided on the recording surface of a base material containing cellulose pulp. Among these, a plastic film is preferable, and a recording medium in which a resin coating layer is provided on the recording surface of a base material containing cellulose pulp is also preferable.

### <Ink>

The ink used for the recording method according to the present disclosure is an ink jet aqueous ink containing a particle having a specific gravity of 3.8 gram per cubic centimeter (g/cm³) or more. Hereinafter, each component constituting the ink will be described in detail.

### (Particle)

The ink contains a particle having a specific gravity of 3.8 gram per cubic centimeter (g/cm³) or more. The particle is a component which has a high specific gravity as a component typically to be added to an ink and is capable of stirring the ink in the vicinity of the ejection orifice. “Particle” may be any component as long as the specific gravity thereof is 3.8 gram per cubic centimeter (g/cm³) or more. For example, the particle may be a pigment, a resin particle, or the like described below. Further, the particle having a specific gravity of 3.8 gram per cubic centimeter (g/cm³) or more may be used alone or two or more kinds of such particles may be used in combination. Hereinafter, “particle having a specific gravity of 3.8 gram per cubic centimeter (g/cm³) or more” will also be simply referred to as “particle”. The specific gravity of the particle is preferably 6.0 gram per cubic centimeter (g/cm³) or less and more preferably 5.0 gram per cubic centimeter (g/cm³) or less.

Here, the specific gravity of the particle is the specific gravity determined by the structure of the particle. The specific gravity of the particle can be measured, for example, by a method (gas replacing method) in conformity with JIS R 1620 or a method (gay-lussac type specific gravity bottle (pycnometer) method) in conformity with JIS Z 8807. In the examples described below, the specific gravity of the particle is calculated using a gay-lussac type specific gravity bottle (pycnometer) method by measuring the specific gravity of a liquid containing a coloring material, also measuring the specific gravity of components such as water and a resin, and obtaining a difference between the specific gravities. The specific gravity may be measured using the particle separated from the ink.

From the viewpoint of efficiently exhibiting the stirring effect of the ink in the vicinity of the ejection orifice, the content (% by mass) of the particle in the aqueous ink is preferably 0.5% by mass or more to 20.0% by mass or less with respect to the total mass of the ink. In a case where the content of the particle is less than 0.5% by mass, the amount of the components contributing to stirring is extremely small, and thus the image unevenness cannot be sufficiently suppressed in some cases. Meanwhile, in a case where the content of the particle is more than 20.0% by mass, since the content thereof is extremely high, the viscosity of the ink is likely to increase, and the stirring efficiency is degraded. As a result, the image unevenness cannot be sufficiently suppressed.

The particle diameter of the particle is also an important factor in efficiently exhibiting the stirring effect of the ink in the vicinity of the ejection orifice. The volume-based cumulative 50% particle diameter (nm) of the particle is preferably 200 nm or more to 300 nm or less. The volume-based cumulative 50% particle diameter of the particle is the particle diameter that is 50% in a case of integration from the small particle diameter side based on the total volume of the measured particles in the particle diameter integration curve. The volume-based cumulative 50% particle diameter of the particle can be measured, for example, with a particle size analyzer using a dynamic light scattering method under the measurement conditions described below. In a case where the particle diameter thereof is less than 200 nm, since the size of the particle is extremely small, the stirring efficiency is degraded, and thus the image unevenness cannot be sufficiently suppressed in some cases. Meanwhile, in a case where the particle diameter thereof is more than 300 nm, since the size of the particle is extremely large, the particle is likely to be destabilized in the ink. As a result, the image unevenness cannot be sufficiently suppressed in some cases.

### (Coloring Material)

It is preferable that the ink contain a coloring material. A pigment or a dye can be used as the coloring material. Among these, a pigment is preferably used. The content (% by mass) of the coloring material in the ink is preferably 0.1% by mass or more to 20.0% by mass or less and more preferably 1.0% by mass or more to 20.0% by mass or less with respect to the total mass of the ink. Further, the content (% by mass) of the titanium oxide particle in the ink is particularly preferably 1.0% by mass or more to 15.0% by mass or less with respect to the total mass of the ink.

Specific examples of the pigment include an inorganic pigment such as carbon black or titanium oxide, and an organic pigment such as azo, phthalocyanine, quinacridone, isoindolinone, imidazolone, diketopyrrolopyrrole or dioxazine.

As a pigment dispersion method, a resin-dispersed pigment formed of a resin as a dispersant or a self-dispersible pigment in which a hydrophilic group is bonded to the particle surface of the pigment can be used. Further, a resin-bonded pigment in which an organic group containing a resin is chemically bonded to the particle surface of the pigment, a microcapsule pigment in which the particle surface of the pigment is coated with a resin, or the like can be used. Among these, it is preferable that the pigment be a self-dispersible pigment. In a case where the pigment is dispersed by a resin (resin dispersant), since the amount of components that are likely to stay increases by the amount of the dispersant and the viscosity of the ink is likely to increase, the stirring efficiency is degraded in some cases. As a result, the image unevenness cannot be sufficiently suppressed.

It is preferable to use a resin dispersant that can disperse the pigment in an aqueous medium using the action of an anionic group as the resin dispersant for dispersing the pigment in an aqueous medium. The following resins and particularly a water-soluble resin among the resins can be used as the resin dispersant. The content (% by mass) of the pigment in the ink is preferably 0.3 times or more to 10.0 times or less in terms of the mass ratio with respect to the content of the resin dispersant.

As the self-dispersible pigment, a pigment in which an anionic group such as a carboxylic acid group, a sulfonic acid group or a phosphonic acid group is bonded to the particle surface of the pigment directly or via other atomic groups (—R—) can be used. The anionic group may be of an acid type or a salt type and may be a dissociable state partially or entirely in a case where the anionic group is of a salt type. Examples of the cation serving as a counter ion include an alkali metal cation, aluminum and organic aluminum in the case where the anionic group is of a salt type. Specific examples of the other atomic groups (—R—) include a linear or branched alkylene group having 1 to 12 carbon atoms, an arylene group such as a phenylene group or a naphthylene group, a carbonyl group, an amino group, an amide group, a sulfonyl group, an ester group and an ether group. Further, a group obtained by combining these groups may be used.

A dye containing an anionic group is preferably used as the dye. Specific examples of the dye include dyes such as azo, triphenylmethane, (aza) phthalocyanine, xanthene, and anthrapyridone. The coloring material is preferably a pigment and more preferably a resin-dispersed pigment.

As described above, the particle may be a coloring material (pigment). Specifically, a titanium oxide particle or a zirconia particle can be used as the particle having a specific gravity of 3.8 gram per cubic centimeter (g/cm³) or more. Among these, it is preferable that the particle be a titanium oxide particle. Further, the titanium oxide particle is preferably a particle that is not dispersed by a resin as described above and more preferably a particle that is dispersed at least by an action of silica.

An inorganic oxide such as titanium oxide reacts with a water molecule constituting an aqueous medium in an aqueous ink so that a hydroxy group (hereinafter, also referred to as “surface hydroxy group”) is generated on the surface thereof. Therefore, the ink jet aqueous ink is typically used in a state of being subjected to a surface treatment with an inorganic oxide such as alumina or silica in order to further improve the storage stability of the ink while the generated hydroxy group is utilized. The surface hydroxy group of the titanium oxide particle has properties unique to the inorganic oxide corresponding to the inorganic compound used for the surface treatment, and the isoelectric point, which is an index of strength as an acid, varies depending on the kind of inorganic compound.

Therefore, the titanium oxide itself is an inorganic oxide, the surface of the titanium oxide particle exhibits the properties of the inorganic oxide corresponding to the inorganic compound used in the surface treatment, and the surface charge of the titanium oxide particle strongly depends on the pH of the aqueous medium, the kind of the surface treatment agent and the amount of the surface treatment agent to be used.

That is, the expression “titanium oxide is a particle that is dispersed at least by an action of silica” denotes that at least a part of the surface of the titanium oxide particle is coated with silica and dispersed by an action of the surface hydroxy group. Here, in a case where the ink contains an excessive amount of a water-soluble resin (for example, 0.01 times or more in terms of the mass ratio with respect to the content of titanium oxide), the dispersion of the particle using the action of silica is considered to be destabilized. Further, addition of a material that assists the dispersion is not excluded.

The titanium oxide is a white pigment, and three crystal forms, which are a rutile type, an anatase type and a brookite type, are present. Among these, rutile type titanium oxide is preferable. Examples of an industrial method of producing titanium oxide include a sulfuric acid method and a chlorine method, and the titanium oxide used in the present disclosure may be produced by any production method.

The volume-based cumulative 50% particle diameter of the titanium oxide particle is preferably 200 nm or more to 500 nm or less and more preferably 200 nm or more to 400 nm or less. The volume-based cumulative 50% particle diameter (D₅₀) of the titanium oxide is the particle diameter that is 50% in a case of integration from the small particle diameter side based on the total volume of the measured particles in the particle diameter integration curve. The D₅₀ of the titanium oxide particle can be measured by setting SetZero to 30 seconds, the number of times of measurement to three times, the measurement time to 180 seconds, the shape to a nonspherical shape and the refractive index to 2.60. A particle size analyzer by a dynamic light scattering method can be used as the particle size distribution measuring device. It goes without saying that the measurement conditions and the like are not limited to the description above.

The surface of the titanium oxide may be coated (surface treatment) with an inorganic oxide or an organic substance. Among such titanium oxides, it is preferable to use a titanium oxide subjected to a surface treatment with alumina or silica. The surface treatment is expected to suppress photocatalytic activity performance and improve dispersibility. In the present specification, “alumina” is a general term for an oxide of aluminum such as aluminum oxide. Further, in the present specification, “silica” is a general term for silicon dioxide or a substance formed of silicon dioxide. The most of alumina and silica coating the titanium oxide are present in the form of silicon dioxide and aluminum oxide.

Examples of a method of measuring the proportion of alumina and silica in the titanium oxide particle, that is, the coating amount of the alumina and silica include quantitative analysis of aluminum and a silicon element using inductively coupled plasma (ICP) emission spectrometry. In this case, the proportion thereof can be calculated by assuming that the atoms coating the surface of the titanium oxide are all oxides and converting the obtained value of aluminum and silicon into the oxides thereof, that is, alumina and silica.

Examples of the surface treatment method for the titanium oxide include a wet treatment and a dry treatment. For example, titanium oxide is dispersed in a liquid medium and reacts with surface treatment agents such as sodium aluminate and sodium silicate to carry out a surface treatment so that the titanium oxide has desired characteristics that can also be adjusted by appropriately changing the ratio between these surface treatment agents. An inorganic oxide such as zinc oxide or zirconia and an organic substance such as a polyol can be used for the surface treatment in addition to the alumina and silica as long as the effects of the present disclosure are not impaired.

Examples of the surface treatment method for the titanium oxide include a wet treatment and a dry treatment. For example, titanium oxide is dispersed in a liquid medium and reacts with surface treatment agents such as sodium aluminate and sodium silicate to carry out a surface treatment so that the titanium oxide has desired characteristics that can also be adjusted by appropriately changing the ratio between these surface treatment agents. An inorganic oxide such as zinc oxide or zirconia and an organic substance such as a polyol can be used for the surface treatment in addition to the alumina and silica as long as the effects of the present disclosure are not impaired. As described above, since the titanium oxide particle is preferably dispersed at least by the action of silica, it is preferable that at least a part of the surface be coated with silica.

The ink may contain other pigments in addition to titanium oxide. In this case, inks of colors other than white can also be used. The content (% by mass) of the other pigments in the ink is preferably 0.1% by mass or more to 5.0% by mass or less and more preferably 0.1% by mass or more to 1.0% by mass or less with respect to the total mass of the ink. In addition, the particle diameter D₅₀ (nm) of the other pigments may be less than 160 nm.

### (Resin)

The ink can contain a resin. The content (% by mass) of the resin in the ink is preferably 0.1% by mass or more to 20.0% by mass or less and more preferably 0.5% by mass or more to 15.0% by mass or less with respect to the total mass of the ink.

The resin can be added to the ink to stabilize the dispersion state of the pigment, that is, to serve as a resin dispersant or an assistant thereof. Further, the resin can be added to the ink to improve various characteristics of an image to be recorded. Examples of the form of the resin include a block copolymer, a random copolymer, a graft copolymer and a combination thereof. Further, the resin may be a water-soluble resin that can be dissolved in an aqueous medium or a resin particle that is dispersed in an aqueous medium.

### [Composition of Resin]

Examples of the resin include an acrylic resin, a urethane-based resin and an olefin-based resin. Among these, an acrylic resin or a urethane-based resin is preferable, and an acrylic resin formed of a unit derived from (meth)acrylic acid or (meth)acrylate is more preferable.

An acrylic resin having a hydrophilic unit and a hydrophobic unit as constituent units is preferable as the acrylic resin. Among such examples, a resin having a hydrophilic unit derived from (meth)acrylic acid and a hydrophobic unit derived from at least one selected from the group consisting of a monomer having an aromatic ring and a (meth)acrylic acid ester-based monomer is preferable. Particularly, a resin having a hydrophilic unit derived from (meth)acrylic acid and a hydrophobic unit derived from at least one selected from the group consisting of styrene and α-methylstyrene is preferable. These resins are likely to interact with a pigment and thus can be suitably used as a resin dispersant for dispersing the pigment.

The hydrophilic unit is a unit containing a hydrophilic group such as an anionic group. The hydrophilic group can be formed by polymerizing a hydrophilic monomer containing a hydrophilic group. Specific examples of the hydrophilic monomer containing a hydrophilic group include an acidic monomer containing a carboxylic acid group such as (meth)acrylic acid, itaconic acid, maleic acid or fumaric acid, and an anionic monomer such as an anhydride or a salt of the acidic monomer. Examples of a cation constituting a salt of the acidic monomer include an ion such as lithium, sodium, potassium, ammonium or organic ammonium. The hydrophobic unit is a unit containing no hydrophilic group such as an anionic group. The hydrophobic unit can be formed, for example, by containing no hydrophilic group such as an anionic group and polymerizing a hydrophobic monomer. Specific examples of the hydrophobic monomer include a monomer having an aromatic ring such as styrene, α-methylstyrene or benzyl (meth)acrylate, and a (meth)acrylic acid ester-based monomer such as methyl (meth)acrylate, butyl(meth)acrylate and 2-ethylhexyl(meth)acrylate.

The urethane-based resin can be obtained, for example, by reacting a polyisocyanate with a polyol. Further, the urethane-based resin may be obtained by further reacting a chain extender. Examples of the olefin-based resin include polyethylene and polypropylene.

### [Properties of Resin]

In the present specification, the expression “resin is water-soluble” denotes that the resin is present in an aqueous medium in a state where a particle having a particle diameter that can be measured by a dynamic light scattering method is not formed in a case where the resin is neutralized with an alkali equivalent to the acid value. Whether the resin is water-soluble can be determined by the following method. First, a liquid (resin solid content: 10% by mass) containing a resin neutralized with an alkali (sodium hydroxide, potassium hydroxide or the like) equivalent to the acid value is prepared. Next, the prepared liquid is diluted to 10 times (on a volume basis) with pure water to prepare a sample solution.

Further, in a case where the particle diameter of the resin in the sample solution is measured by a dynamic light scattering method, the resin can be determined as a water-soluble resin when a particle having a particle diameter is not measured. The measurement here can be performed by setting SetZero to 30 seconds, the number of times of measurement to three times and the measurement time to 180 seconds. Further, a particle size analyzer (for example, trade name “UPA-EX150”, manufactured by NIKKISO CO., Ltd.) using a dynamic light scattering method can be used as a particle size distribution measuring device.

It goes without saying that the particle size distribution measuring device to be used, the measurement conditions and the like are not limited to the description above.

The acid value of the water-soluble resin is preferably 100 mgKOH/g or more to 250 mgKOH/g or less. The weight-average molecular weight of the water-soluble resin is preferably 3,000 or more to 15,000 or less.

The constituent unit of the resin constituting the resin particle can be appropriately selected from the same units as those constituting the resin (water-soluble resin) described below and then used. The acid value of the resin constituting the resin particle is preferably 5 mgKOH/g or more to 100 mgKOH/g or less. The weight-average molecular weight of the resin constituting the resin particle is preferably 1,000 or more to 3,000,000 or less and more preferably 100,000 or more to 3,000,000 or less. The volume-based cumulative 50% particle diameter (D50) of the resin particle measured by the dynamic light scattering method is preferably 50 nm or more to 500 nm or less. The volume-based cumulative 50% particle diameter of the resin particle is the particle diameter that is 50% in a case of integration from the small particle diameter side based on the total volume of the measured particles in the particle diameter integration curve. The volume-based cumulative 50% particle diameter of the resin particle can be measured with a particle size analyzer using a dynamic light scattering method under the measurement conditions described above. The glass transition temperature of the resin particle is preferably 40° C. or higher to 120° C. or lower and more preferably 50° C. or higher to 100° C. or lower. The glass transition temperature (° C.) of the resin particle can be measured by using a differential scanning calorimeter (DSC). The resin particle does not necessarily contain a coloring material. Further, it is preferable that the resin particle be formed of an acrylic resin without using a polyamide-based resin or the like.

### (Wax Particle)

The ink can contain a particle formed of a wax (wax particle).

An image with further improved abrasion resistance can be recorded by using the ink containing the wax particle. The wax may be a composition blended with a component other than the wax or may be the wax itself. The wax particle may be dispersed with a dispersant such as a surfactant or a water-soluble resin. The content (% by mass) of the wax particle in the aqueous ink is preferably 0.5% by mass or more to 5.0% by mass or less with respect to the total mass of the ink.

The wax in a broad sense is an ester of a water-insoluble higher monohydric or dihydric alcohol and a fatty acid and includes an animal-based wax and a vegetable-based wax, but excludes oils and fats. The wax in a broad sense include fats having a high melting point, a mineral-based wax, a petroleum-based wax and a blended substance or a modified substance of various waxes. In the recording method of the present disclosure, the wax in a broad sense can be used without particular limitation. The wax in a broad sense can be classified into a natural wax, a synthetic wax, a blended substance (blended wax) thereof, and a modified substance (modified wax) thereof.

Examples of the natural wax include an animal-based wax such as beeswax, spermaceti or wool wax (lanolin), a vegetable-based wax such as wood wax, carnauba wax, sugarcane wax, palm wax, candelilla wax or rice wax, a mineral-based wax such as montan wax, and a petroleum-based wax such as paraffin wax, microcrystalline wax or petrolatum. Examples of the synthetic wax include a hydrocarbon-based wax such as Fischer-Tropsch wax or polyolefin wax (such as polyethylene wax or polypropylene wax). The blended wax is a mixture of various waxes. The modified wax is a wax obtained by performing a modification treatment such as oxidation, hydrogenation, alcohol modification, acrylic modification or urethane modification on the various waxes. At least one wax selected from the group consisting of microcrystalline wax, Fischer-Tropsch wax, polyolefin wax, paraffin wax, and a modified substance or mixture thereof is preferable as the wax. Among these, a blended substance of a plurality of kinds of waxes is more preferable, and a blended substance of a petroleum-based wax and a synthetic wax is particularly preferable.

It is preferable that the wax particle be a solid at room temperature (25° C.). The melting point (C) of the wax is preferably 40° C. or higher to 120° C. or lower and more preferably 50° C. or higher to 100° C. or lower. The melting point of the wax particle can be measured in conformity with the test method described in 5.3.1 (melting point test method) of JIS K 2235:1991 (petroleum wax). When the test method described in 5.3.2 is used in a case of microcrystalline wax, petrolatum and a mixture of a plurality of kinds of waxes, the melting point can be more accurately measured. The melting point of the wax is likely to be affected by characteristics such as the molecular weight (the melting point increases as the molecular weight increases), the molecular structure (the melting point increases in a case of a linear molecular structure and decreases in a case of a branched molecular structure), the crystallinity (the melting point increases as the crystallinity is high) and the density (the melting point increases as the density increases).

Therefore, a wax having a desired melting point can be obtained by controlling these characteristics.

### (Aqueous Medium)

The ink is an aqueous ink containing water as an aqueous medium. The ink can contain water or an aqueous medium which is a mixed solvent of water and a water-soluble organic solvent. Deionized water (ion exchange water) is preferably used as water. The content (% by mass) of water in the ink is preferably 50.0% by mass or more to 95.0% by mass or less with respect to the total mass of the ink.

The water-soluble organic solvent is not particularly limited as long as the solvent is water-soluble (preferably soluble in water at 25° C. in any proportion). Specifically, monohydric or polyhydric alcohols, alkylene glycols, glycol ethers, nitrogen-containing polar compounds, sulfur-containing polar compounds or the like can be used. The content (% by mass) of the water-soluble organic solvent in the ink is preferably 3.0% by mass or more to 50.0% by mass or less and more preferably 10.0% by mass or more to 40.0% by mass or less with respect to the total mass of the ink.

### (Other Additives)

The ink can contain, in addition to the additives described above, various additives such as a surfactant, a pH adjuster, a rust inhibitor, a preservative, a fungicide, an antioxidant, a reducing inhibitor, an evaporation promotor and a chelating agent as necessary. Here, it is preferable that the ink contain no reaction agent to be contained in the reaction solution described below. Among these, it is preferable that the ink contain a surfactant. The content (% by mass) of the surfactant in the ink is preferably 0.1% by mass or more to 5.0% by mass or less and more preferably 0.1% by mass or more to 2.0% by mass or less with respect to the total mass of the ink. Examples of the surfactant include an anionic surfactant, a cationic surfactant and a nonionic surfactant. Among these, from the viewpoint of being used to adjust various physical properties of the ink, a nonionic surfactant exhibiting an effect even with a small amount of use is preferable.

### (Physical Properties of Ink)

The ink is an ink to be applied to the ink jet method, it is preferable that the physical properties be appropriately controlled. The surface tension of the ink at 25° C. is preferably 10 mN/m or more to 60 mN/m or less and more preferably 20 mN/m or more to 40 mN/m or less. The surface tension of the ink can be adjusted by appropriately determining the kind or the content of the surfactant in the ink. Further, the viscosity of the ink at 25° C. is preferably 1.0 mPa·s or more to 10.0 mPa·s or less. The pH of the ink at 25° C. is preferably 7.0 or more to 9.0 or less. The pH of the ink can be measured with a typical pH meter equipped with a glass substrate or the like.

### <Reaction Solution>

It is preferable that the recording method according to the present disclosure include a reaction solution applying step of applying an aqueous reaction solution containing a reaction agent that reacts with the aqueous ink to the recording medium. Hereinafter, the aqueous reaction solution will also be simply referred to as a reaction solution. A high-quality image can be recorded even on the non-absorbing recording medium described above by using the reaction solution along with the ink. It is preferable that the reaction solution be applied to the recording medium before the application of the ink.

The reaction solution reacts with the ink when comes into contact with the ink and aggregates the components (components containing an anionic group such as a resin and a self-dispersing pigment) in the ink, and contains a reaction agent. Examples of the reaction agent include a polyvalent metal ion, a cationic component such as a cationic resin, and an organic acid.

Examples of the polyvalent metal ion include divalent metal ions such as Ca²⁺, Cu²⁺, Ni²⁺, Mg²⁺, Sr²⁺, B^{a2+} and Zn²⁺, and trivalent metal ions such as Fe³⁺, Cr³⁺, Y³⁺ and Al³⁺. In order to allow the reaction solution to contain the polyvalent metal ion, a polyvalent metal salt (may be a hydrate) formed by bonding a polyvalent metal ion and an anion to each other can be used. Examples of the anion include inorganic anions such as Cl⁻, Br⁻, I⁻, ClO⁻, ClO₂, ClO₃⁻, ClO₄₋, NO₂⁻, NO₃⁻, SO₄²⁻, CO₃²⁻, HCO₃⁻, PO₄³⁻, HPO₄²⁻ and H₂PO₄⁻, and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. In a case where the polyvalent metal ion is used as the reaction agent, the content (% by mass) thereof in terms of the polyvalent metal salt in the reaction solution is preferably 1.0% by mass or more to 20.0% by mass or less with respect to the total mass of the reaction solution.

The reaction solution containing an organic acid has a buffer capacity in an acidic region (pH of less than 7.0 and preferably 2.0 to 5.0) and thus efficiently aggregates anionic groups of the components present in the ink in the form of an acid. Examples of the organic acid include a monocarboxylic acid such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid or coumaric acid and a salt thereof, a dicarboxylic acid such as oxalic acid, malonic acid, succinic acid, glutaric acid, adipic acid, maleic acid, fumaric acid, itaconic acid, sebacic acid, phthalic acid, malic acid or tartaric acid, a salt thereof and a hydrogen salt thereof, a tricarboxylic acid such as citric acid or trimellitic acid, a salt thereof and a hydrogen salt thereof, and a tetracarboxylic acid such as pyromellitic acid, a salt thereof and a hydrogen salt thereof. In a case where the organic acid is used as the reaction agent, the content (% by mass) of the organic acid in the reaction solution is preferably 1.0% by mass or more to 50.0% by mass or less with respect to the total mass of the reaction solution.

Examples of the cationic resin include a resin having a structure of primary to tertiary amines and a resin having a structure of a quaternary ammonium salt. Specific examples thereof include a resin having a structure of vinylamine, allylamine, vinylimidazole, vinylpyridine, dimethylaminoethyl methacrylate, ethyleneimine, guanidine, diallyldimethylammonium chloride or an alkylamine/epichlorohydrin condensate. In order to increase the solubility in the reaction solution, the cationic resin and an acidic compound can be used in combination or the cationic resin can be subjected to a quaternization treatment. In a case where the cationic resin is used as the reaction agent, the content (% by mass) of the cationic resin in the reaction solution is preferably 0.1% by mass or more to 10.0% by mass or less with respect to the total mass of the reaction solution.

### EXAMPLES

Hereinafter, the present disclosure will be described in more detail with reference to examples, comparative examples and reference examples. The present disclosure is not limited to the following examples unless the gist thereof is overstepped. In regard to the component amount, “parts” and “%” are on a mass basis unless otherwise specified. Further, a dispersion liquid of a titanium oxide particle will be referred to as “pigment dispersion liquid”.

### <Method of Measuring Physical Property Value>

### (Determination Whether Resin was Resin Particle and Volume-Based Cumulative 50% Particle Diameter of Resin Particle and Wax Particle)

A liquid containing a resin was diluted with ion exchange water to prepare a sample having a resin content of about 1.0%. With the sample, the volume-based cumulative 50% particle diameter D₅₀ of the resin particle was measured with a particle size distribution meter using a dynamic light scattering method under the following measurement conditions. “NANOTRAC WAVE II-Q” (trade name, manufactured by MicrotracBEL Corp.) was used as the particle size distribution meter. In a case where a particle having a particle diameter was measured by this measurement method, it was determined that the resin was “resin particle” (“water-dispersible resin”). Meanwhile, in a case where a particle having a particle diameter was not measured by this measurement method, it was determined that the resin was not “resin particle” (“water-soluble resin”). Further, the resin particle dyed with a fluorescent dye described below was also measured in the same manner as described above. When the particle diameter of the wax particle was measured, the volume-based cumulative 50% particle diameter D₅₀ of the wax particle was measured by performing the same operation as described above except that a liquid containing a wax particle was used in place of the liquid containing a resin.

### [Measurement Conditions]

SetZero: 30 s
Number of times of measurement: 3 times
Measurement time: 120 seconds
Shape: true spherical shape
Refractive index: 1.6
Density: 1.0

(Volume-based cumulative 50% particle diameter of pigment)

A Pigment Dispersion Liquid was Diluted with Ion Exchange Water to Prepare a sample having a pigment content of about 0.01%. With the sample, the average particle diameter D₅₀ (volume-based cumulative 50% particle diameter) of the pigment was measured with the particle size distribution meter described above under the following measurement conditions.

### [Measurement Conditions]

SetZero: 30 s
Number of times of measurement: 3 times
Measurement time: 120 seconds
Shape: non-spherical shape
Refractive index: 1.5 (2.6 in case of titanium oxide particle)
Density: 1.0 (4.0 in case of titanium oxide particle)

### (Confirmation of Surface Treatment of Titanium Oxide Particle)

Quantitative analysis of aluminum and a silicon element was performed with an inductively coupled plasma (ICP) emission spectrometer using a liquid obtained by adding a titanium oxide particle to nitric acid as a sample. Here, the mass ratio thereof was calculated by assuming that the atoms coating the surface of the titanium oxide were all oxides and converting the obtained value of aluminum and silicon into the oxides thereof, that is, alumina and silica. That is, when the value of aluminum and silicon was obtained, this indicates that the titanium oxide was subjected to a surface treatment with alumina and silica.

### (Melting Point of Wax Particle)

The melting point T_{M}(° C.) of a wax formed of a single component was measured in conformity with a test method described in 5.3.1 (melting point test method) of JIS K 2235:1991 (petroleum wax). The melting point of a wax (wax mixture) formed of a plurality of components was measured in conformity with a test method described in 5.3.2 of JIS K 2235:1991.

### <Preparation of Reaction Solution>

Respective components (unit: %) listed in Table 1 were mixed and sufficiently stirred, and filtered through a cellulose acetate filter (manufactured by ADVANTEC CO., LTD.) having a pore size of 3.0 μm under pressure, thereby preparing each reaction solution. In Table 1, “CATIOMASTER PDT-2” denotes an aqueous solution of a cationic resin, which is a trade name of an amine-epichlorohydrin condensation type polymer aqueous solution (manufactured by Yokkaichi Chemica Company Limited, content of resin: 60.0% by mass). Further, “Capstone FS3100” denotes a trade name of a fluorine-based nonionic surfactant (manufactured by LEHVOSS Group), and “PROXEL GXL(S)” denotes a trade name of a preservative (manufactured by Arch Chemicals, Inc.).

TABLE 1
Composition of reaction solution

| | Reaction solution | | |
|---|---|---|---|
| | 1 | 2 | 3 |
| CATIOMASTER PDT-2 | 3.3 | | |
| Succinic acid | | 2.0 | |
| Magnesium sulfate heptahydrate | | | 4.1 |
| 1,2-Butanediol | 20.0 | 20.0 | 20.0 |
| Capstone FS3100 | 0.5 | 0.5 | 0.5 |
| PROXEL GXL(S) | 0.2 | 0.2 | 0.2 |
| Ion exchange water | 76.0 | 77.3 | 75.2 |

### <Preparation of Pigment Dispersion Liquid>

### <Preparation of Pigment Dispersion Liquid>

A pigment dispersion liquid was prepared by the following procedures. The characteristics of the pigment are listed in Table 2.

### (Pigment Dispersion Liquids 1 to 3, 5 and 6)

40.0 parts of the pigment listed in Table 2, 1.2 parts of 3-(methoxy (polyoxyethylene) 9-12) propyltrimethoxysilane and ion exchange water in an amount set such that the total amount of the components reached 100.0 parts were mixed and preliminarily dispersed using a homogenizer. Thereafter, a dispersion treatment was performed with a paint shaker at 25° C. for 12 hours using zirconia beads with a diameter of 0.5 mm. The zirconia beads were separated by filtration, and an appropriate amount of ion exchange water was added thereto as necessary, thereby preparing pigment dispersion liquids 1 to 3, 5 and 6 in which the content of the titanium oxide particle was 40.0%.

### (Pigment Dispersion Liquid 4)

Zirconia beads with a particle diameter of 0.1 mm and a particle diameter of 0.5 mm (both trade names “TORAYCERAM Zirconia Beads”, manufactured Toray Industries, Inc.) by were mixed at a mass ratio of 1:4. 1,080 parts of the obtained mixture and 300 parts of ion exchange water were placed in a batch type bead mill (trade name “EASY NANO RMB”, manufactured by AIMEX Co., Ltd.) and stirred at a peripheral speed of 8.4 m/s for 8 hours. Thereafter, coarse particles were separated by filtration using a membrane filter with a pore size of 1.0 μm (manufactured by Sartorius AG), and the concentration of the obtained filtrate was adjusted, thereby obtaining a pigment dispersion liquid 4 in which the content of the zirconia particle was 30.0%. The D₅₀ (nm) of the zirconia particle was 295 nm.

### (Pigment Dispersion Liquid 7)

81.6 parts of butyl methacrylate and 18.4 parts of methacrylic acid were polymerized by a known method to synthesize a water-soluble acrylic resin. Ion exchange water containing potassium hydroxide in an amount equimolar to the acid value thereof was added thereto to neutralize the acid group, and an appropriate amount of ion exchange water was further added thereto, thereby obtaining an aqueous solution of a water-soluble resin in which the content of the resin was 40.0%. the acid value of the water-soluble resin was 120.0 mgKOH/g. a pigment dispersion liquid 7 in which the content of the titanium oxide particle was 40.0% and the content of the resin (water-soluble resin) was 8.0% was prepared by the same procedures as those for the pigment dispersion liquids 1 to 3 and 5 except that 1.2 parts of 3-(methoxy (polyoxyethylene) 9-12) propyltrimethoxysilane was changed to 20.0 parts of the aqueous solution of the water-soluble resin obtained above.

### (Pigment Dispersion Liquid 8)

A styrene-ethyl acrylate-acrylic acid copolymer (resin 1) with an acid value of 150 mgKOH/g and a weight-average molecular weight of 8,000 was prepared. 20.0 parts of the resin 1 was neutralized with potassium hydroxide in an amount equimolar to the acid value thereof, and an appropriate amount of pure water was added thereto to prepare an aqueous solution of the resin 1 in which the content of the resin (solid content) was 20.0%, 15.0 parts of a pigment (trade name “MA-100”, manufactured by Mitsubishi Chemical Corporation, carbon black), 22.5 parts of the aqueous solution of the resin 1 and 62.5 parts of pure water were mixed to obtain a mixture. The obtained mixture and 200 parts of zirconia beads having a diameter of 0.3 mm were placed in a batch type vertical sand mill (manufactured by AIMEX Co., Ltd.) and dispersed for 5 hours while being cooled with water. Coarse particles were removed by centrifugation, and the resultant was filtered under pressure through a cellulose acetate filter (manufactured by ADVANTEC CO., LTD.) having a pore size of 3.0 μm, thereby preparing a pigment dispersion liquid 8 in which the content of the pigment was 15.0% and the content of the resin dispersant (resin 1) was 4.5%.

### (Pigment Dispersion Liquid 9)

An aqueous dispersion liquid of commercially available colloidal silica (trade name “Colloidal Silica MP-2040”, content of colloidal silica: 40.0%) was used as a pigment dispersion liquid 9.

TABLE 2
Composition and characteristics of pigment

| Pigment | | | | Specific |
|---|---|---|---|---|
| dispersion | | Type of | Surface | gravity |
| liquid | Pigment | particle | treatment | (g/cm³) |
| 1 | Trade name “TITANIX JR-403”, manufactured | Titanium | Alumina | 4.0 |
| | by TAYCA CORPORATION | oxide | and silica | |
| 2 | Trade name “TITANIX JR-405”, manufactured | Titanium | Alumina | 4.1 |
| | by TAYCA CORPORATION | oxide | | |
| 3 | Trade name “TITANIX JR-800”, manufactured | Titanium | Alumina | 3.9 |
| | by TAYCA CORPORATION | oxide | and silica | |
| 4 | Trade name “TORAYCERAM Zirconia Beads”, | Zirconia | None | 5.7 |
| | manufactured by Toray Industries, Inc. (mixture) | | | |
| 5 | Trade name “TIPAQUE PT-501R”, manufactured | Titanium | None | 4.2 |
| | by ISHIHARA SANGYO KAISHA, LTD. | oxide | | |
| 6 | Trade name “TITONE R-38L”, manufactured by | Titanium | Alumina | 4.1 |
| | SAKAI CHEMICAL INDUSTRY CO., LTD. | oxide | | |
| 7 | Trade name “TITANIX JR-405”, manufactured | Titanium | Alumina | 4.1 |
| | by TAYCA CORPORATION | oxide | | |
| 8 | Trade name “MA-100”, manufactured by | Carbon | None | 1.8 |
| | Mitsubishi Chemical Corporation | black | | |
| 9 | Trade name “MP-2040”, manufactured by Nissan | Colloidal | None | 2.0 |
| | Chemical Corporation | silica | | |

### <Production of Resin Particle>

Resin particles 1 to 3 were synthesized by the following procedures. The specific gravities of all the resin particles 1 to 3 were less than 3.8 gram per cubic centimeter (g/cm³).

### (Resin Particle 1)

74.0 parts of ion exchange water and 0.2 parts of potassium persulfate were added to a four-necked flask provided with a stirrer, a reflux cooling device and a nitrogen gas introduction pipe and mixed. Further, 24.0 parts of ethyl methacrylate, 1.5 parts of methacrylic acid, and 0.3 parts of a reactive surfactant were mixed to prepare an emulsion. As the reactive surfactant, “ADEKA REASOAP ER20” (trade name, manufactured by ADEKA Corporation, nonionic surfactant, addition mole number of ethylene oxide group: 20) was used.

The prepared emulsion was added dropwise to the four-necked flask over one hour in a nitrogen atmosphere, and the polymerization reaction was performed for 2 hours while the mixture was stirred at 80° C. The mixture was cooled to 25° C., and ion exchange water and an aqueous solution containing potassium hydroxide in an amount equimolar to the acid value of the resin particle were added thereto, thereby preparing an aqueous dispersion liquid of the resin particle 1 in which the content of the resin particle (solid content) was 40.0%.

### (Resin Particle 2)

81.8 parts of ion exchange water and 0.2 parts of potassium persulfate were added to a four-necked flask provided with a stirrer, a reflux cooling device and a nitrogen gas introduction pipe and mixed. Further, 16.1 parts of ethyl methacrylate, 1.6 parts of methoxypolyethylene glycol methacrylate, and 0.3 parts of the reactive surfactant were mixed to prepare an emulsion. As the methoxypolyethylene glycol methacrylate, “BLEMMER PME1000” (trade name, manufactured by NOF CORPORATION, addition mole number of ethylene oxide group: about 23) was used. The prepared emulsion was added dropwise to the four-necked flask over one hour in a nitrogen atmosphere, and the polymerization reaction was performed for 2 hours while the mixture was stirred at 80° C.

The mixture was cooled to 25° C., and ion exchange water was added thereto, thereby preparing an aqueous dispersion liquid of the resin particle 2 in which the content of the resin particle (solid content) was 40.0%.

### (Resin Particle 3)

A 1 L four-necked flask provided with a stirrer, a temperature regulator, a water separator and a nitrogen gas introduction pipe was charged with 112.5 parts (0.77 moles) of adipic acid and 16.9 parts of xylene, and the mixture was heated to 50° C. Next, 308 parts (0.62 moles) of a dimer diamine was gradually added thereto, and the mixture was stirred at 150° C. for 60 minutes. Thereafter, the mixture was gently heated to 175° C. and subjected to a dehydration reaction for 150 minutes, thereby obtaining a polyamide-based resin. 20 parts of the obtained polyamide-based resin, 5 parts of polyoxyethylene-2-ethylhexyl ether and 15 parts of propylene glycol monomethyl ether were mixed with each other and heated to 120° C. so that the components were dissolved. Thereafter, 2 parts of N,N-dimethylethanolamine was added thereto and mixed into the mixture. This mixture was gradually added to a 500 mL four-necked flask to which 203 parts of high-purity water heated to 40° C. was added. Next, the mixture was stirred at 40° C. for 10 minutes and allowed to stand in a constant-temperature tank at 80° C. for 24 hours, thereby obtaining an aqueous dispersion liquid of the resin particle 3 in which the content of the resin particle was 10.0%.

### <Preparation of Wax Particle>

The respective components listed in Table 3 were mixed with each other, the temperature and the pressure were appropriately adjusted, and the waxes were dispersed. An appropriate amount of pure water was added to dilute the mixture, thereby obtaining each aqueous dispersion liquid of wax particles 1 to 3, in which the total content of the wax and the dispersant was 30.0%. As the dispersant, an aqueous solution of a dispersant with a dispersant content of 40.0%, obtained by adding an appropriate amount of ion exchange water to an emulsifier (trade name “Rhodafac RS-710”, manufactured by Rhodia Novecare), was used. The characteristics of the obtained wax particles are listed in Table 3. The specific gravities of all the resin particles 1 to 3 were less than 3.8 gram per cubic centimeter (g/cm³).

TABLE 3
Synthesis condition for wax particle and characteristics thereof

| | Synthesis condition | | | | Characteristics | |
|---|---|---|---|---|---|---|
| | Wax | | Dispersant | Emulsification | Melting | |
| Wax | | Amount used | Amount used | temperature | point | D₅₀ |
| particle | Type | (parts) | (parts) | (° C.) | T_{M} (° C.) | (nm) |
| 1 | Fischer-Tropsch wax | 70.0 | 30.0 | 95.0 | 90 | 300 |
| 2 | Paraffin wax | 70.0 | 30.0 | 95.0 | 90 | 300 |
| 3 | Polyethylene wax | 70.0 | 30.0 | 95.0 | 90 | 300 |

### <Preparation of Ink>

The respective components of the kinds and the amounts listed in the upper columns of Tables 4 and 5 were mixed and stirred. Thereafter, the mixture was filtered under pressure through a membrane filter (manufactured by Sartorius AG) with a pore size of 5.0 μm to prepare each ink. ACETYLENOL E60 (trade name, manufactured by Kawaken Fine Chemicals Co., Ltd.) is a nonionic surfactant. Further, “HYDRAN APX-101H” (trade name, manufactured by DIC Corporation) was used as the polyurethane-based resin. The content of the high specific gravity particle in the ink is listed in the columns of “content P (%) of particle”, and the D₅₀ of the high specific gravity particle is listed in the columns of “D₅₀ (nm) of particle”. Further, since the inks 18 to 20 contained no high gravity particle, the D₅₀ of the pigment is listed in the columns of “D₅₀ (nm) of particle”.

TABLE 4
Composition and characteristics of ink

| | Ink | | | | | | | | | |
|---|---|---|---|---|---|---|---|---|---|---|
| | 1 | 2 | 3 | 4 | 5 | 6 | 7 | 8 | 9 | 10 |
| Pigment dispersion liquid 1 | 37.5 | 37.5 | 37.5 | 37.5 | 37.5 | 37.5 | | | 2.5 | |
| Pigment dispersion liquid 2 | | | | | | | 37.5 | | | |
| Pigment dispersion liquid 3 | | | | | | | | 37.5 | | |
| Pigment dispersion liquid 4 | | | | | | | | | | 50.0 |
| Pigment dispersion liquid 5 | | | | | | | | | | |
| Pigment dispersion liquid 6 | | | | | | | | | | |
| Pigment dispersion liquid 7 | | | | | | | | | | |
| Pigment dispersion liquid 8 | | | | | | | | | 20.0 | |
| Pigment dispersion liquid 9 | | | | | | | | | | |
| Aqueous dispersion liquid of resin particle 1 | 25.0 | 25.0 | 25.0 | | 25.0 | 25.0 | 25.0 | 25.0 | 25.0 | 25.0 |
| Aqueous dispersion liquid of resin particle 2 | | | | 25.0 | | | | | | |
| Aqueous dispersion liquid of resin particle 3 | | | | | | | | | | |
| Polyurethane-based resin | | | | | | | | | | |
| Aqueous dispersion liquid of wax particle 1 | 5.0 | | | 5.0 | 5.0 | 5.0 | 5.0 | 5.0 | 5.0 | 5.0 |
| Aqueous dispersion liquid of wax particle 2 | | 5.0 | | | | | | | | |
| Aqueous dispersion liquid of wax particle 3 | | | 5.0 | | | | | | | |
| 1,2-Propanediol | 15.0 | 15.0 | 15.0 | 15.0 | 10.0 | 10.0 | 15.0 | 15.0 | 15.0 | 15.0 |
| 1,2-Butanediol | | | | | 5.0 | | | | | |
| 1,3-Propanediol | | | | | | 5.0 | | | | |
| 2-Ethyl -1,3 Hexanediol | | | | | | | | | | |
| Oleic acid | | | | | | | | | | |
| 2-Pyrrolidone | 3.0 | 3.0 | 3.0 | 3.0 | 3.0 | 3.0 | 3.0 | 3.0 | 3.0 | 3.0 |
| ACETYLENOL E60 | 0.9 | 0.9 | 0.9 | 0.9 | 0.9 | 0.9 | 0.9 | 0.9 | 0.9 | 0.9 |
| Ion exchange water | 13.6 | 13.6 | 13.6 | 13.6 | 13.6 | 13.6 | 13.6 | 13.6 | 28.6 | 1.1 |
| Content P (%) of particle | 15.0 | 15.0 | 15.0 | 15.0 | 15.0 | 15.0 | 15.0 | 15.0 | 1.0 | 15.0 |
| D₅₀ (nm) of particle | 250 | 250 | 250 | 250 | 250 | 250 | 210 | 270 | 250 | 295 |

TABLE 5
Composition and characteristics of ink

| | Ink | | | | | | | | | | |
|---|---|---|---|---|---|---|---|---|---|---|---|
| | 11 | 12 | 13 | 14 | 15 | 16 | 17 | 18 | 19 | 20 | 21 |
| Pigment dispersion liquid 1 | | | | 1.0 | 1.25 | 50.0 | 52.5 | | | | |
| Pigment dispersion liquid 2 | | | | | | | | | | | |
| Pigment dispersion liquid 3 | | | | | | | | | | | |
| Pigment dispersion liquid 4 | | | | | | | | | | | |
| Pigment dispersion liquid 5 | 37.5 | | | | | | | | | | |
| Pigment dispersion liquid 6 | | 37.5 | | | | | | | | | |
| Pigment dispersion liquid 7 | | | 37.5 | | | | | | | | 37.5 |
| Pigment dispersion liquid 8 | | | | 20.0 | 20.0 | | | | 20.0 | | |
| Pigment dispersion liquid 9 | | | | | | | | 37.5 | | 37.5 | |
| Aqueous dispersion liquid of resin particle 1 | 25.0 | 25.0 | 25.0 | 25.0 | 25.0 | 25.0 | 20.0 | 25.0 | 25.0 | 25.0 | |
| Aqueous dispersion liquid of resin particle 2 | | | | | | | | | | | |
| Aqueous dispersion liquid of resin particle 3 | | | | | | | | | | | 1.0 |
| Polyurethane-based resin | | | | | | | | | | | 25.0 |
| Aqueous dispersion liquid of wax particle 1 | 5.0 | 5.0 | 5.0 | 5.0 | 5.0 | 5.0 | 5.0 | 5.0 | 5.0 | 5.0 | |
| Aqueous dispersion liquid of wax particle 2 | | | | | | | | | | | |
| Aqueous dispersion liquid of wax particle 3 | | | | | | | | | | | |
| 1,2-Propanediol | 15.0 | 15.0 | 15.0 | 15.0 | 15.0 | 15.0 | 15.0 | 15.0 | 15.0 | 15.0 | 30.0 |
| 1,2-Butanediol | | | | | | | | | | | |
| 1,3-Propanediol | | | | | | | | | | | |
| 2-Ethyl -1,3 Hexanediol | | | | | | | | | | | 1.0 |
| Oleic acid | | | | | | | | | | 0.2 | |
| 2-Pyrrolidone | 3.0 | 3.0 | 3.0 | 3.0 | 3.0 | 3.0 | 3.0 | 3.0 | 3.0 | 3.0 | |
| ACETYLENOL E60 | 0.9 | 0.9 | 0.9 | 0.9 | 0.9 | 0.9 | 0.9 | 0.9 | 0.9 | 0.9 | 0.9 |
| Ion exchange water | 13.6 | 13.6 | 13.6 | 30.1 | 29.85 | 1.1 | 3.6 | 13.6 | 31.1 | 13.4 | 4.6 |
| Content P (%) of particle | 15.0 | 15.0 | 15.0 | 0.4 | 0.5 | 20.0 | 21.0 | 0.0 | 0.0 | 0.0 | 15.0 |
| D₅₀ (nm) of particle | 180 | 310 | 290 | 250 | 250 | 250 | 250 | 200 | 100 | 200 | 290 |

### <Recording Medium>

The following recording medium was prepared.
Recording medium 1: trade name “Graphical Ink Jet Media Transparent PET GIY-0305 1220 mm×30 M”, manufactured by Lintec Corporation, material: PET, water absorption amount from start of contact to 30 msec^{1/2} in Bristow method: 0 mL/m² or more to 10 mL/m² or less
Recording medium 2: trade name “Recycled-Content Colored Construction Paper (fresh color)C-57, bear (dark black)”, manufactured by Daio Paper Corporation, size: wide roll, water absorption amount from start of contact to 30 msec^{1/2} in Bristow method: more than 10 mL/m²

### <Evaluation>

An ink tank of an ink jet recording device having a recording head listed on the left side of Table 6 was filled with each of the prepared inks and each of the prepared reaction solutions. In the examples listed as “1” in the columns of the recording head in Table 6, an ink accommodating unit of the ink jet recording device (ink jet recording device in which the recording head performs reciprocal scanning in a direction intersecting the arrangement direction of the ejection orifice arrays) having a main portion shown in FIG. 1A was filled with the ink.

In the examples listed as “2” in the columns of the recording head, the ink accommodating unit of the ink jet recording device, in which a line head 800 shown in FIG. 20 was installed such that the ejection orifice array intersected the conveyance direction of the recording medium, was filled with the ink. The line head 800 does not relatively move with respect to the recording medium P during the recording on the recording medium P.

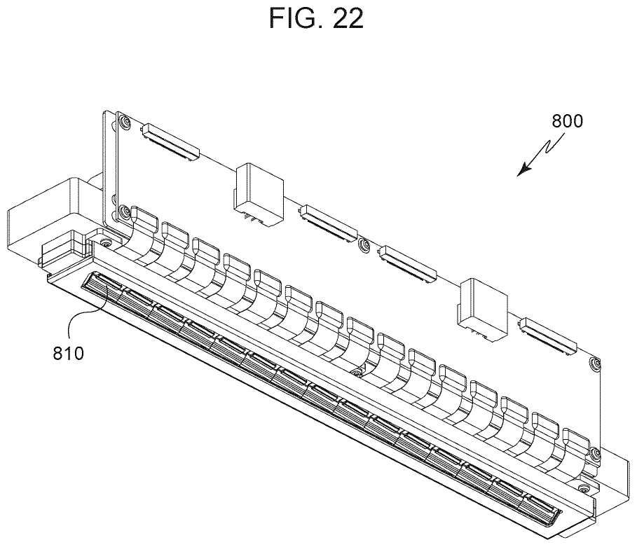

In the example listed as “3” in the columns of the recording head, supply channels circulating the ink by communicating with each other between the ejection elements were provided inside the recording head, but the ink accommodating unit of the recording head having no collecting channel was filled with the ink. Here, FIG. 22 is a perspective view showing a linear recording head, and shows a line head in which the ejection element substrates 810 with arranged ejection orifice arrays are linearly arranged.

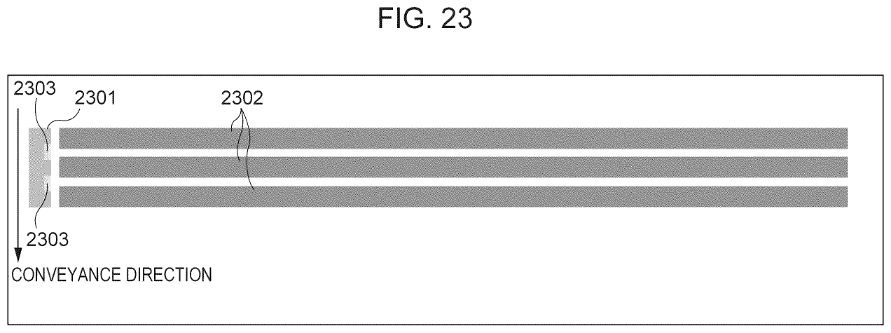

The image pattern shown in FIG. 23 was recorded on the recording medium using the ink jet recording device with the above-described configuration under the conditions listed on the left side of Table 6, and the evaluation was performed in the following manner. In the examples and the comparative examples using the recording head “1” or the recording head “3”, the image pattern shown in FIG. 23 was recorded on the recording medium. In FIG. 23, “2303” reproduces a situation where the ink is intermittently ejected by the multipass type recording method and denotes that the intermittent ejection stability is excellent when image unevenness has not occurred in this region. Hereinafter, the term “width” denotes the length of the recording medium in a direction orthogonal to the conveyance direction, and the term “length” denotes the length of the recording medium in the conveyance direction.

First, the reaction solution was applied to the entire surface of the recording medium such that the recording duty reached 20%. Thereafter, as shown in FIG. 23, a solid image 2301 with a width of 30 mm, a length of 110 mm and an ink recording duty of 60% was recorded by providing a space of 30 mm at the left end of the recording medium in a direction intersecting the conveyance direction. Further, a pattern in which a solid image 2302 having a width of 1,000 mm, a length of 30 mm and an ink recording duty of 300% was provided three times to be adjacent to the solid image 2301 with a gap of 30 mm, and with a space of 10 mm in the conveyance direction of the recording medium was recorded. The recording environment was set to a temperature of 25° C. and a relative humidity of 50%. In the present examples, an image recorded under a condition that one ink droplet having a volume of 4.0 pL is applied to a unit area of 1/1,200 inches×1/1,200 inches is defined as a recording duty of 100%. In Comparative Example 1, an image was recorded without operating the circulation pump 500 shown in FIG. 5.

For the reference example using the recording head “2”, an image pattern in which the image pattern shown in FIG. 23 is rotated 90 degrees clockwise is recorded on the recording medium. The image pattern was recorded in one pass by carrying paper at 50 inches per second. In Reference Example 3, assuming Japanese Patent Laid-Open No. 2017-101232, the aforementioned image pattern was recorded and evaluated using a recording head “2”.

In the obtained pattern shown in FIG. 23, the presence or absence of image unevenness in the site denoted by 2303 was visually confirmed, and the suppression of the image unevenness was evaluated according to the following evaluation criteria. In the present disclosure, “AA”, “A” and “B” are in acceptable levels, and “C” is in an unacceptable level according to the evaluation criteria in each item described below. The evaluation results are listed in Table 6.
AA: Image unevenness was not confirmed in an image recorded by any number of passes (8 passes, 16 passes and 32 passes).
A: Image unevenness was confirmed in an image recorded by 32 passes, but image unevenness was not confirmed in an image recorded by 8 passes and 16 passes.
B: Image unevenness was confirmed in an image recorded by 16 passes and 32 passes, but image unevenness was not confirmed in an image recorded by 8 passes.
C: Image unevenness was confirmed in an image recorded by any number of passes (8 passes, 16 passes and 32 passes).

TABLE 6
evaluation conditions and evaluation results

| | | Evaluation conditions | | | | | | |
|---|---|---|---|---|---|---|---|---|
| | | | | | | Scanning | Circulation | Evaluation results |
| | | Reaction | | Recording | Recording | speed | flow rate | Suppression image |
| | | solution | Ink | head | medium | (inch/s) | (mm/s) | unevenness |
| Example | 1 | 1 | 1 | 1 | 1 | 50 | 20 | AA |
| | 2 | 1 | 2 | 1 | 1 | 50 | 20 | AA |
| | 3 | 1 | 3 | 1 | 1 | 50 | 20 | AA |
| | 4 | 1 | 4 | 1 | 1 | 50 | 20 | AA |
| | 5 | 1 | 5 | 1 | 1 | 50 | 20 | AA |
| | 6 | 1 | 6 | 1 | 1 | 50 | 20 | AA |
| | 7 | 2 | 1 | 1 | 1 | 50 | 20 | AA |
| | 8 | 3 | 1 | 1 | 1 | 50 | 20 | AA |
| | 9 | 1 | 7 | 1 | 1 | 50 | 20 | AA |
| | 10 | 1 | 8 | 1 | 1 | 50 | 20 | AA |
| | 11 | 1 | 1 | 1 | 1 | 30 | 20 | AA |
| | 12 | 1 | 9 | 1 | 1 | 50 | 20 | AA |
| | 13 | 1 | 10 | 1 | 1 | 50 | 20 | A |
| | 14 | 1 | 11 | 1 | 1 | 50 | 20 | B |
| | 15 | 1 | 12 | 1 | 1 | 50 | 20 | B |
| | 16 | 1 | 13 | 1 | 1 | 50 | 20 | A |
| | 17 | 1 | 14 | 1 | 1 | 50 | 20 | A |
| | 18 | 1 | 15 | 1 | 1 | 50 | 20 | AA |
| | 19 | 1 | 16 | 1 | 1 | 50 | 20 | AA |
| | 20 | 1 | 17 | 1 | 1 | 50 | 20 | B |
| | 21 | 1 | 1 | 1 | 1 | 50 | 9 | A |
| | 22 | 1 | 1 | 1 | 1 | 50 | 10 | AA |
| | 23 | 1 | 1 | 1 | 1 | 50 | 30 | AA |
| | 24 | 1 | 1 | 1 | 1 | 50 | 31 | B |
| | 25 | 1 | 1 | 1 | 1 | 19 | 20 | A |
| | 26 | 1 | 1 | 1 | 1 | 20 | 20 | AA |
| | 27 | 1 | 1 | 1 | 1 | 80 | 20 | AA |
| | 28 | 1 | 1 | 1 | 2 | 50 | 20 | A |
| Comparative | 1 | 1 | 1 | 1 | 1 | 50 | 0 | C |
| Example | 2 | 1 | 1 | 3 | 1 | 50 | 20 | C |
| | 3 | 1 | 18 | 1 | 1 | 50 | 20 | C |
| | 4 | 1 | 19 | 1 | 1 | 50 | 20 | C |
| | 5 | 1 | 20 | 1 | 1 | 50 | 20 | C |
| Reference | 1 | 1 | 1 | 2 | 1 | 0 | 20 | AA |
| Example | 2 | 1 | 18 | 2 | 1 | 0 | 20 | AA |
| | 3 | 1 | 21 | 2 | 1 | 0 | 20 | AA |

The results of Example 10 were evaluated as “AA” similar to Example 1, but Example 1 was excellent when compared to Example 10.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-096028, filed Jun. 12, 2023, and Japanese Patent Application No. 2024-087056, filed May 29, 2024, which are hereby incorporated by reference herein in their entirety.

What is claimed is:

1. An ink jet recording method of ejecting an aqueous ink from a plurality of ejection orifices to record an image on a unit area of a recording medium, the ink jet recording method comprising:
performing a plurality of times of reciprocal scanning of a recording head on the unit area while performing reciprocal scanning in a direction intersecting a conveyance direction of the recording medium,
wherein the recording head includes:
the plurality of ejection orifices for ejecting the aqueous ink,
a pressure chamber that communicates with the plurality of ejection orifices,
an ejection unit that includes an ejection element disposed in the pressure chamber and generating energy for ejecting the aqueous ink from the plurality of ejection orifices,
a circulation unit that includes a supply channel for supplying the aqueous ink to the pressure chamber of the ejection unit,
a collecting channel for collecting the aqueous ink from the pressure chamber of the ejection unit, and
wherein the aqueous ink contains a particle having a specific gravity of 3.8 gram per cubic centimeter (g/cm³) or more.

2. The ink jet recording method according to claim 1, wherein the particle has a volume-based cumulative 50% particle diameter (nm) of 200 nm or more to 300 nm or less.

3. The ink jet recording method according to claim 1, wherein the particle is a titanium oxide particle having a surface at least partially coated with silica, and the titanium oxide particle is dispersed at least by an action of silica.

4. The ink jet recording method according to claim 1, wherein a content (% by mass) of the particle in the aqueous ink is 0.5% by mass or more to 20.0% by mass or less with respect to a total mass of the aqueous ink.

5. The ink jet recording method according to claim 1, wherein the aqueous ink in a circulation path has a flow rate (mm/s) of 10 mm/s or more to 30 mm/s or less.

6. The ink jet recording method according to claim 1, wherein a movement speed (inch/s) of the recording head in the reciprocal scanning is 20 inch/s or more.

7. The ink jet recording method according to claim 1, wherein the recording head further includes a circulation pump that makes the aqueous ink in the collecting channel flow into the supply channel.

8. The ink jet recording method according to claim 1,
wherein the circulation unit includes a first pressure adjustment unit that adjusts a pressure of the supply channel,
wherein the first pressure adjustment unit includes a first valve chamber, a first pressure control chamber, and a first opening that makes the first valve chamber and the first pressure control chamber communicate with each other, and
wherein the first valve chamber includes a first valve that opens and closes the first opening according to a change in pressure of the first pressure control chamber.

9. The ink jet recording method according to claim 8,
wherein the circulation unit further includes a second pressure adjustment unit that adjusts a pressure of the collecting channel,
wherein the second pressure adjustment unit includes a second valve chamber, a second pressure control chamber and a second opening that makes the second valve chamber and the second pressure control chamber communicate with each other, and
wherein the second valve chamber includes a second valve that opens and closes the second opening according to a change in pressure of the second pressure control chamber.

10. The ink jet recording method according to claim 1, wherein a water absorption amount of the recording medium from a start of contact to 30 msec^{1/2} in a Bristow method is 10 mL/m² or less.

11. An ink jet recording device to eject an aqueous ink from a plurality of ejection orifices to record an image on a unit area of a recording medium, the ink jet recording device comprising:
a recording head configured to perform a plurality of times of reciprocal scanning on the unit area while performing reciprocal scanning in a direction intersecting a conveyance direction of the recording medium,
wherein the recording head includes:
the plurality of ejection orifices for ejecting the aqueous ink,
a pressure chamber that communicates with the plurality of ejection orifices,
an ejection unit that includes an ejection element disposed in the pressure chamber and generating energy for ejecting the aqueous ink from the plurality of ejection orifices,
a circulation unit that includes a supply channel for supplying the aqueous ink to the pressure chamber of the ejection unit,
a collecting channel for collecting the aqueous ink from the pressure chamber of the ejection unit, and
wherein the aqueous ink contains a particle having a specific gravity of 3.8 gram per cubic centimeter (g/cm³) or more.
